(19) United States
(12) Patent Application Publication
(10) Pub. No.: US 2025/0367613 A1
(43) Pub. Date: Dec. 4, 2025

(54) MESOPOROUS POLYIMIDE THIN FILMS AS DENDRITE-SUPPRESSING SEPARATORS FOR ALKALI METAL BATTERIES

(71) Applicant: VIRGINIA TECH INTELLECTUAL PROPERTIES, INC., Blacksburg, VA (US)

(72) Inventors: Guoliang LIU, Blacksburg, VA (US); Dong GUO, Blacksburg, VA (US)

(21) Appl. No.: 18/865,629

(22) PCT Filed: May 13, 2023
(86) PCT No.: PCT/US2023/022167

§ 371 Date: Nov. 13, 2024

Related U.S. Application Data
(60) Provisional application No. 63/341,782, filed on May 13, 2022.

(51) Int. Cl. B01D 71/80; B01D 67/00; H01M 50/414

(52) U.S. Cl. CPC B01D 71/80; B01D 67/0011; H01M 50/414; B01D 2325/02832; B01D 2325/02833

(57) ABSTRACT

In various aspects, methods of preparing mesoporous polyimide membranes are provided. The polyimide membranes are useful as separators in various electrochemical devices, in particular in alkali metal batteries where the controllable pore size and high modulus of the membranes can prevent or suppress dendrite formation in alkali metal batteries. Electrochemical devices, and in particular alkali metal batteries, incorporating the polyimide membranes as separators are also provided.

### CROSS-REFERENCE TO RELATED APPLICATIONS

This Application claims the benefit of U.S. Provisional Application No. 63/341,782, filed on May 13, 2013 and entitled “MESOPOROUS POLYIMIDE THIN FILMS AS DENDRITE-SUPPRESSING SEPARATORS FOR LITHIUM-METAL BATTERIES,” which is incorporated herein by reference in its entirety.

### BACKGROUND

Lithium-ion batteries have become widely prevalent and are highly favored in various applications due to their numerous advantages. These batteries possess a high energy density, allowing for more power storage in a compact size. They exhibit excellent cycle life, enabling them to be recharged and discharged multiple times without significant degradation. Moreover, lithium-ion batteries have a low self-discharge rate, ensuring that stored energy is retained for extended periods. They also offer high power output, making them suitable for applications that require quick bursts of energy, such as electric vehicles and portable electronics. Additionally, lithium-ion batteries are known for their relatively low maintenance requirements and lack of memory effect, allowing for flexible usage and convenience. Lithium-metal batteries represent a high-performance energy storage technology because metallic lithium provides a high theoretical capacity of 3860 mAh/g, a low density of 0.534 g/cm3, and a low electrochemical potential of −3.040 V vs. the standard hydrogen electrode.¹⁻⁶

Despite their widespread use, lithium-ion batteries do have certain limitations that researchers are actively working on addressing. Since the debut in the 1970s, the commercialization of lithium-metal batteries has been plagued due to some of the severe safety concerns.^{3,5} Another significant challenge is their reliance on lithium, a relatively scarce and costly resource. This limitation has prompted researchers to explore alternative alkali metals such as sodium, potassium, and magnesium to develop batteries with similar performance but using more abundant materials. This combined with the potential risk of thermal runaway and the associated safety concerns are areas of focus for researchers. They are investigating new electrolyte formulations and advanced cell designs to enhance the stability and safety of these batteries. Moreover, efforts are being made to improve the energy density and charging speed of alkali metal batteries, aiming to provide even more efficient and powerful energy storage solutions for future applications.

### SUMMARY

In various aspects, the disclosure provides methods of making polyimide membranes, polyimide membranes prepared by the methods, and electrochemical devices utilizing the polyimide membranes as separators. Not wishing to be bound by any particular theory, it is believed that the small and uniform pore sizes and high modulus of the polyimide membranes provide for the suppression of dendrite growth in alkali metal batteries.

In some aspects, the disclosure includes a method of preparing a mesoporous polyimide membrane comprising casting an A-B, A-B-A, or A-B-C block copolymer on a substrate to form a precursor, heating the precursor film to a temperature from about 100° C. to about 300° C. for a time interval to form the polyimide membrane; wherein the mesoporous polyimide membrane comprises a plurality of mesopores wherein a median diameter of the mesopores is from about 5 nm to about 20 nm as measured by the Nitrogen Sorption Protocol. A and C are each independently thermally labile blocks and B is a polyimide block.

In other aspects, the disclosure includes a mesoporous polyimide membrane prepared according to the above method. In some aspects, a mesoporous polyimide membrane is provided having a polyimide membrane having a plurality of mesopores wherein a median diameter of the mesopores is from about 5 nm to about 20 nm as measured by the Nitrogen Sorption Protocol, and wherein the mesopores are isoporous.

### BRIEF DESCRIPTION OF THE FIGURES

Many aspects of the present disclosure can be better understood with reference to the following drawings. Any components in the drawings are not necessarily to scale, emphasis instead being placed upon clearly illustrating the principles of the present disclosure. Moreover, in the drawings, any reference numerals designate corresponding parts throughout the several views.

FIG. 1 shows an illustrated comparison of a conventional macroporous PP/PE/PP separator, which suffers from short circuits caused by lithium dendrites (left), with the mesoporous polyimide separator of the disclosure, which provides uniform lithium-ion flux. The dashed lines represent lithium-ion flux.

FIG. 2 shows an illustration of a solution casting and chemical imidization process of PLA-b-PAA-b-PLA (LIL) which forms a polyimide-based thin film. Subsequent thermolysis produces a mesoporous polyimide separator for a lithium-metal battery.

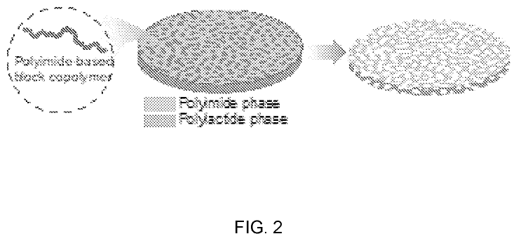

FIG. 3 shows a synthesis scheme to prepare PLA-b-PAA-b-PLA as well as 1H NMR spectrum, wherein indicates a $PLA of 40.2%.

FIG. 4 shows a thermogravimetric analysis of LIL films which indicates a fPLA of 39.0%, and suggests a thermolysis temperature of PLA at 280° C.

FIG. 5 shows a graph of an isothermal weight loss of PLA-b-PI-b-PLA at 280° C.

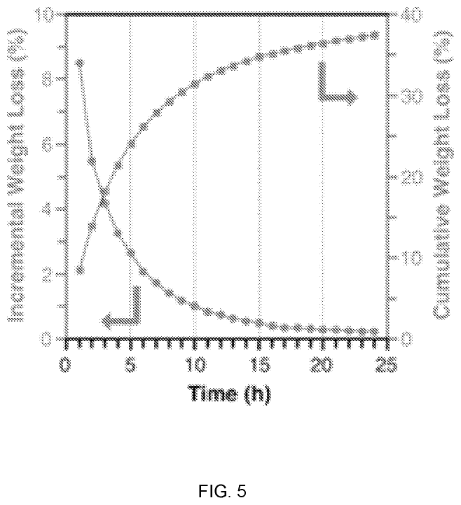

FIG. 6 shows FT-IR spectra of PLA, PI, and LIL thermalized at 60, 220, 280, and 350° C. The dashed line at 1752 cm-1 corresponds to the carbonyl stretching of PLA.

FIG. 7 shows a LIL thin film before thermolysis at 280° C. The inset portion is an optical image of a 19-mm-wide LIL disc.

FIG. 8 shows a LIL thin film after thermolysis at 280° C. for 24 hours. The inset portion is an optical image of a 19-mm-wide LIL disc.

FIG. 9 shows a graph of a pore size distribution of the mesoporous polyimide film of a median pore width of 21 nm.

FIG. 10 shows a graph of thermogravimetric analysis of mesoporous polyimide thin film which indicates a Td,5% of 540° C.

FIG. 11 shows a dynamic mechanical analysis indicating a high E′ of 1.80 GPa at RT. The E′ is greater than E″ at all testing temperatures between 25 and 450° C.

FIG. 12 shows a graph of ionic impedances of the polyimide separators of the disclosure.

FIG. 13 shows a graph of the rate capabilities of the polyimide separators of the disclosure wherein current densities ranged from 0.2 to 1.0 mA/cm2.

FIG. 14 is a graph of a potential profile of a PP/PE/PP separator wherein current densities ranged from 0.2 to 1.0 mA/cm2.

FIG. 15 is a graph of a potential profile of the polyimide separators of the disclosure, wherein current densities ranged from 0.2 to 1.0 mA/cm2.

FIG. 16 is a graph of a Li/Li symmetric battery test comparing the potential profile of a PP/PE/PP separator with the polyimide separator of the disclosure. The PP/PE/PP separator profile indicates a short circuit at about 50 hours of cycling. The polyimide separator of the disclosure shows safe charging and discharging for 500 hours. The inset graph shows the detailed potential profiles after cycling for 130 hours. The battery with the polyimide separator had a potential of about 0.03V whereas the battery with the PP/PE/PP separator had a potential of about 0.01V.

FIG. 17 shows an SEM image of lithium deposits that after charging/discharging for 130 hours, the lithium-metal electrode contacting a PP/PE/PP separator shows a dendritic morphology. The inset image shows kinked dendrites with a width of 200 nm. The scale bar in the main image is 5 microns. In the inset image, the scale bar is 500 nm.

FIG. 18 shows an SEM image of lithium deposits that after charging/discharging for 130 hours, the lithium-metal electrode contacting a PP/PE/PP separator shows a flat-top protrusion morphology. The inset image shows a more detailed view. The scale bar in the main image is 5 microns. The scale bar in the inset image is 500 nm.

FIG. 19 shows the top surface of a LIL film before thermolysis.

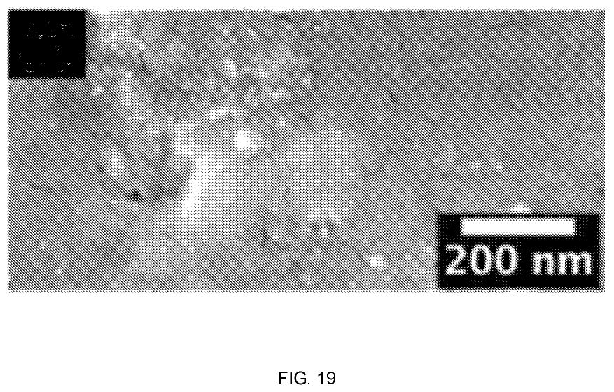

FIG. 20 shows the cross-section of a LIL film before thermolysis.

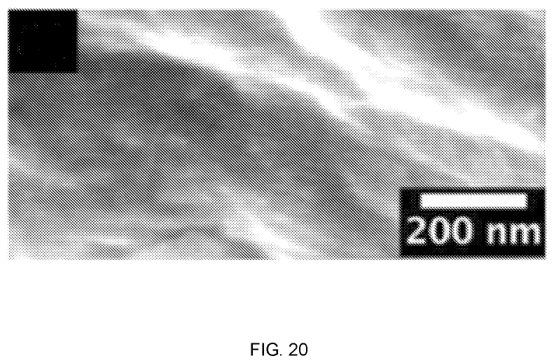

FIG. 21 shows the bottom surface of a LIL film before thermolysis.

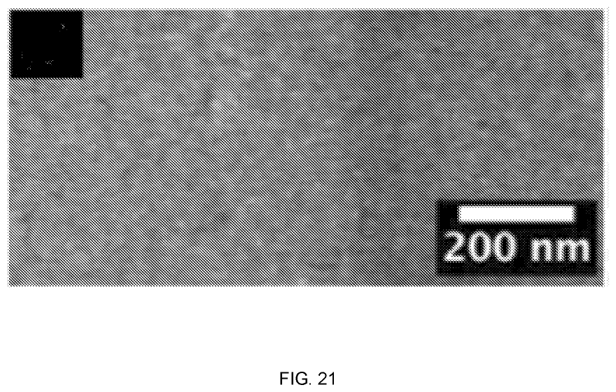

FIG. 22 shows the top surface of a LIL film after thermolysis.

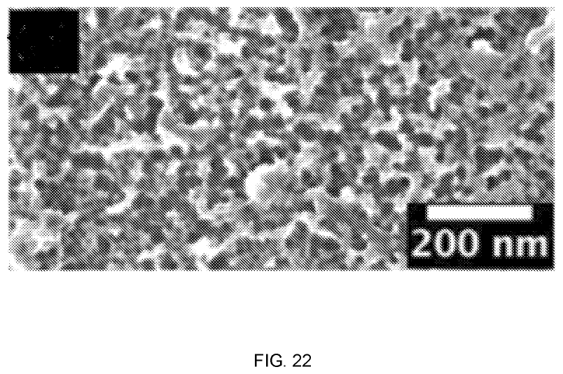

FIG. 23 shows the cross-section of a LIL film after thermolysis.

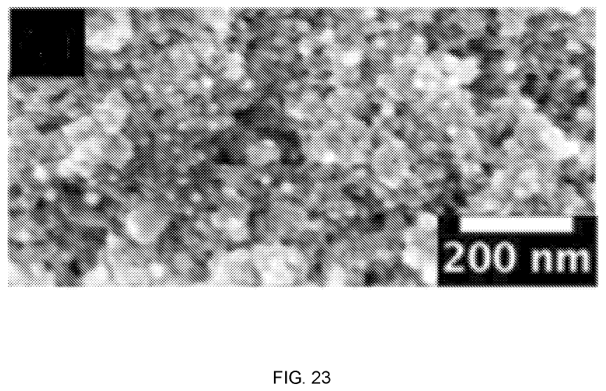

FIG. 24 shows the bottom surface of a LIL film after thermolysis.

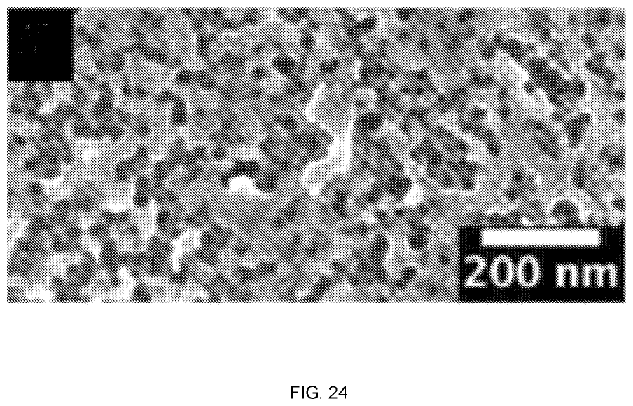

FIG. 25 shows an image of a LIL film after thermolysis. The dark dots represent mesopores.

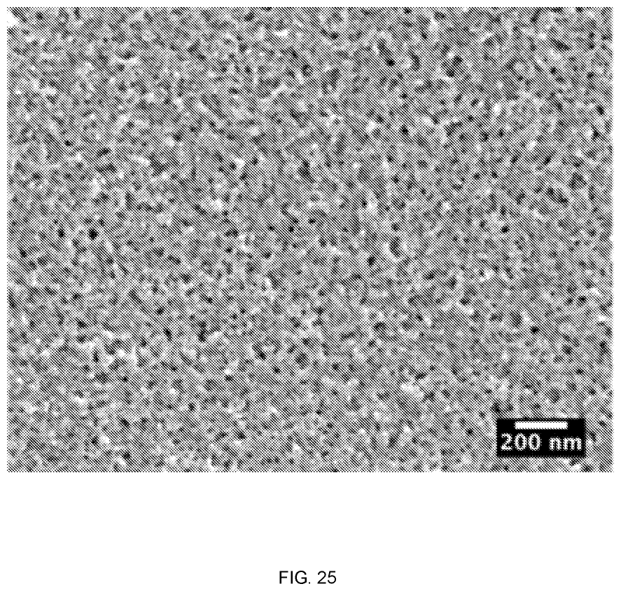

FIG. 26 shows a graph of the number of pores compared to the pore area after an image analysis of the image of FIG. 25. The median pore width was calculated to be about 24 nm.

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

Dendrite formation is a well-known challenge in lithium and other alkali metal batteries that can lead to significant problems. Dendrites are tiny, needle-like structures that can form during the charging and discharging process, especially when the battery is subjected to repeated cycles. These dendrites can penetrate the separator between the battery's positive and negative electrodes, causing internal short circuits and potential safety hazards. Additionally, dendrite growth can lead to reduced battery performance, decreased cycle life, and even premature failure.

Researchers are actively studying dendrite formation to better understand the underlying mechanisms and develop strategies to mitigate or prevent their formation. Various approaches, including new electrolyte additives, coatings, and advanced electrode designs, are being explored to suppress dendrite growth and improve the overall safety and longevity of alkali metal batteries. Lithium dendrites arise from nonuniform nucleation of lithium on the surface.⁷⁻⁹ The amplified electrical field near the lithium crystals further promotes dendritic growth.8,10 The resulting lithium dendrites expose large reactive surfaces and consume the electrolyte to form a solid-electrolyte interphase (SEI).^{2, 8, 11-12} The uneven stripping/plating of lithium cause accumulative stress and brittle fractures in the SEI, further drying the electrolyte to grow more SEI.^{2, 11, 13-14} This uncontrollable process increases the internal impedance, deteriorates the performance of lithium-metal batteries,¹² and worse, causes short-circuits and even fire hazard once the growing dendrites traverse the separator.^{6-7, 10} Suppressing lithium dendrites is imperative to guarantee the safe operation of high-performance lithium-metal batteries.

In the past decades, various strategies have been evaluated to suppress lithium dendrites, including (1) employing high-modulus solid-state electrolytes to block the dendritic growth,⁵⁻¹⁸ (2) applying concentrated liquid electrolytes or pulse charging currents to mitigate the depletion of Li+ near the anode surface,^{2, 19-21} (3) increasing operation temperatures to facilitate Li+ diffusion,^{4,22} (4) employing three-dimensional lithium-metal electrodes or hosts to enlarge the surface area,^{9, 23-24} (5) engineering the composition, density and elasticity of SEI to ensure interphase stability.^{2, 24-27} Although the high-modulus solid-state electrolytes are promising to suppress the dendritic growth, lithium dendrites can still penetrate the grain boundaries of the electrolytes.^{16, 28-30} Moreover, at room temperature, the solid-state electrolytes usually have limited conductivity and high electrolyte/electrode contact resistance.^{16, 28-30} contrarily, liquid electrolytes provide high ionic conductivity and good contacts with electrodes, but the dendritic growth is uncontrolled. Especially, the deposition-diffusion competition causes Li+ depletion near the metallic lithium surface, promoting the fast tip-growth of dendrites. High-concentration liquid electrolytes, pulse charging, elevated temperatures, and high-surface-area electrodes mitigate the depletion of Li+ near the metallic lithium surface, but still cannot cease the invasion of lithium dendrites. Although the stable SEI tailors the lithium deposition, the limited mechanical strength is still vulnerable to the dendritic penetration.^{12, 31}

At the frontline of dendritic invasion, high-modulus separators are promising for suppressing unhealthy dendrite growth in liquid electrolytes. The state-of-the-art separators are made of macroporous polyolefins, such as polyethylene (PE) and polypropylene (PP). However, the large macropores in these state-of-the-art separators are still susceptible to lithium dendrite penetration, causing safety concerns.³² There remains a need for improved separators capable of suppressing dendrite formation and preventing dendrites from penetrating the separators, especially in alkali metal batteries using liquid electrolytes where dendrite formation might otherwise grow uncontrollably.

In this disclosure, it is demonstrated that mesopores smaller than the width of lithium dendrites can provide a strong physical barrier and stop lithium dendrite from penetrating the separator, in particular when the mesoporous separators possess a high modulus to withstand the cumulative axial stress.¹ Compared with PE and PP, polyimides have superior mechanical performance, but controlling the pore size in polyimides at the mesoscale has historically remained challenging. Therefore, in some aspects, this disclosure provides polyimide separators and methods of making polyimide separators with controllable pore sizes.

To synthesize polyimide-based triblock copolymers, various thermally labile blocks have been deployed, such as poly(methyl methacrylate),³³⁻³⁴ polystyrene,³⁵⁻³⁶ poly(α-methyl styrene),³⁷⁻³⁸ polycaprolactone,³⁹⁻⁴² poly(ethylene oxide),⁴³ and poly(propylene oxide).⁴⁴⁻⁴⁸ The triblock copolymers microphase-separate to form domains in tens of nanometers. Via thermolysis, the labile blocks decompose to create mesopores. But high-temperature thermolysis inevitably results in too-fast decomposition of the labile block, produce a large amount of gaseous species, e.g., poly(α-methyl styrene) fully decomposes within 4.5 h at 325° C.³⁷ The gaseous species expands in the softened polyimide matrices, resulting in pore sizes of hundreds of nanometers or even micrometers.³⁵ Thus, in some aspects, a judicious selection of the labile block to achieve a low thermolysis temperature can be important to prepare mesoporous polyimides without perturbing the porous network.

Many modifications and other aspects disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual aspect described and illustrated herein has discrete components and features which may be readily separated from or combined with the features of any of the other several aspects without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications, patents, and patent applications mentioned or cited herein are incorporated herein by reference to disclose and describe the methods and/or materials in connection with which the publications, patents, or patent applications are cited. All such publications, patents, and patent applications are herein incorporated by references as if each individual publication, patent, or patent application were specifically and individually indicated to be incorporated by reference. Such incorporation by reference is expressly limited to the methods and/or materials described in the cited publications, patents, and patent applications and does not extend to any lexicographical definitions from the cited publications, patents, and patent applications. Any lexicographical definition in the publications, patents, and patent applications cited, including any lexicographical definition in any patent or patent application in the priority claim, that is not also expressly repeated in the instant specification should not be treated as such and should not be read as defining any terms appearing in the accompanying claims. The publications, patents, and patent applications discussed herein are provided solely for their disclosure prior to the filing date of the present application. Nothing herein is to be construed as an admission that the present disclosure is not entitled to antedate such publication by virtue of prior disclosure. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Before describing the various aspects of the present disclosure, the following definitions and aspects are provided and should be used unless otherwise indicated. Additional terms may be defined elsewhere in the present disclosure.

### Definitions

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter, or other quantity or characteristic is “about,” “approximate,” or “at or about” whether or not expressly stated to be such. It is understood that where “about,” “approximate,” or “at or about” is used before a quantitative value, the parameter also includes the specific quantitative value itself unless specifically stated otherwise.

As used herein, the term “polymer block” means and includes a grouping of multiple monomer units of a single type (i.e., a homopolymer block) or multiple types (i.e., a copolymer block) of constitutional units into a continuous polymer chain of some length that can part of a larger polymer of an even greater length. As used herein, the term “block copolymer” means and includes a polymer composed of chains where each chain contains two or more polymer blocks as defined above. A wide variety of block polymers are contemplated herein including diblock copolymers (i.e., polymers including two polymer blocks), triblock copolymers (i.e., polymers including three polymer blocks), multiblock copolymers (i.e., polymers including more than three polymer blocks), and combinations thereof.

As used herein, the term “isoporous,” is used to refer to a material or membrane that exhibits a narrow range of pore size deviations, indicating a high level of uniformity in pore size. The specific ranges of pore size deviations that would be considered isoporous can vary depending on the context and application. For microporous materials (typical pore sizes of about 0.2 nanometers to about 2 nanometers), the pore size deviations would typically be less than 15%, less than 10%, or less than 5% of the average pore size. For example, an isoporous microporous material with an average pore size of 1 nm would have a pore size deviation of about 0.15 nm, about 0.1 nm, about 0.05, or less. For mesoporous materials (typical pore sizes of 2 nm-200 nm, 2 nm-100 nm, or 2 nm-50 nm) the pore size deviations would still be relatively small compared to the average pore size, usually less than 25%, less than 20%, less than 15%, or less than 10% of the average pore size. For instance, an isoporous mesoporous material with an average pore size of 10 nm would have a pore size deviation of about 2.5 nm, about 2 nm, about 1.5 nm, about 1 nm or less. For macroporous materials (typical pore sizes exceeding 50 nm, exceeding 100 nm, or exceeding 200 nm), the pore size deviation could be less than 30%, less than 20%, or less than 10% of the average pore size. For example, an isoporous macroporous material with an average pore size of 100 nm would have a pore size deviation of about 30 nm, about 20 m, about 10 nm, or less. As used herein, the term “substantially isoporous” refers to a material where the pore size deviations are no more than 30% larger than the pore size deviations found in an isoporous material. For example, a mesoporous material can be said to be substantially isoporous when the pore size deviations are less than 32.5%, less than 26%, less than 19.5%, or less than 13% of the average pore size.

### Methods of Making Polyimide Membranes

In various aspects, methods of making polyimide membranes are provided herein. The inventors have found that, through a judicious selection of the labile block the various copolymers described herein can self-assemble separate to form domains in tens of nanometers and then the labile blocks can be thermally decomposed without expanding or destroying the polyimide matrix, thereby giving controllable porosities and uniform pore sizes.

In some aspects, a method is provided for preparing a mesoporous polyimide membrane. The methods can include casting an A-B, A-B-A, or A-B-C block copolymer on a substrate to form a precursor film, wherein A and C are each independently thermally labile blocks, and wherein B is a polyimide block. In some aspects, the method includes heating the precursor film to a temperature from about 100° C. to about 300° C. for a time interval to form the polyimide membrane. Heating the precursor film provides for decomposition or all or a portion of the thermally labile blocks, resulting in the polyimide membrane having controllable porosity. By judicious selection of the thermally labile blocks and the heating protocol, the membranes can be made with high degrees or pore uniformity. In some examples, the mesoporous polyimide membrane comprises a plurality of mesopores wherein a median diameter of the mesopores is from about 5 nm to about 100 nm, about 5 nm to about 50 nm, about 5 nm to about 20 nm, about 10 nm to about 30 nm, about 20 nm to about 40 nm, or about 10 nm to about 20 nm as measured by the Nitrogen Sorption Protocol.

### Block Copolymers

Various block copolymers are described herein that can be cast and/or reacted to produce mesoporous polyimide membranes as described herein and demonstrated in the examples.

In some instances, the polymer is a diblock or a triblock copolymer. For example, the polymer can be an A-B, A-B-A, or A-B-C block copolymer. The polymer can in some instances include additional blocks or can have multiple repeated blocks. For instance, it is envisioned that A-B-A-B, A-B-C-B-A block copolymers might also be possible and within the spirit of the disclosure. The requirement is just that the block copolymer contain at least one block that is a polyimide or can be transformed into a polyimide (as described elsewhere herein) and that at least one block is a labile block, preferably a thermally labile block as described further below.

The synthesis of block copolymers containing a thermally labile block and a polyimide block can be achieved through various methods known to those skilled in the art such as through sequential polymerization, through the use of various coupling reactions, or through a depolymerization/repolymerization process. Those skilled in the art will recognize other methods can be used as well.

In sequential polymerization, the block copolymer is prepared by sequentially polymerizing the two monomers, one after the other. The process typically starts with the polymerization of the thermally labile block, followed by the polymerization of the polyimide block. The monomer for the thermally labile block can be selected based on its ability to undergo controlled or living polymerization, allowing precise control over the chain length and molecular weight. After the first block is formed, it is protected, and then the polyimide block is synthesized through a separate reaction. The protection can be achieved through a variety of methods, such as capping the functional end groups or temporarily blocking the reactive sites. Finally, the protecting groups are removed to reveal the functional end groups, resulting in a block copolymer containing both the thermally labile block and the polyimide block.

To achieve precise control over the chain length and molecular weight of the thermally labile block, controlled or living polymerization techniques can be employed. For instance, atom transfer radical polymerization (ATRP) or reversible addition-fragmentation chain transfer (RAFT) polymerization can be utilized to polymerize monomers such as styrene, acrylates, or methacrylates for the labile block. After the polymerization of the labile block, protection of the functional end groups is necessary to prevent unwanted reactions during the subsequent steps. Protecting groups like esters, silyl ethers, or acetyl groups can be employed to temporarily shield the reactive sites.

Using various coupling methods, block copolymers can be created with a thermally labile block and a polyimide block. In this approach, two pre-formed polymers are coupled together to form the block copolymer. The first polymer is a thermally labile polymer, while the second polymer is a precursor to the polyimide block. The coupling reaction can be achieved using various coupling agents or catalysts, depending on the specific polymers involved. The resulting block copolymer contains the thermally labile block and the polyimide block, connected through the coupling reaction.

The polyimide block can be prepared from suitable monomers, such as dianhydrides and diamines, through a two-step process. The first step involves the formation of a poly(amic acid) precursor by the reaction of the dianhydride with the diamine. The reaction occurs in an organic solvent at an elevated temperature. The poly(amic acid) precursor can then be subjected to a thermal treatment or a chemical imidization process to convert it into the polyimide block. This imidization step involves the cyclization of the poly(amic acid) through the loss of water and the formation of imide linkages.

The imidization step can be performed prior to the formation of the block copolymer. However, in some instances the inventors have found it useful to form a precursor polymer containing the poly(amic acid) block first, and then to perform the imidization step prior to or during the casting step. For example, in some instances the inventors have found it useful to first form an A-D, A-D-A, or A-D-C block copolymer, wherein A and C are each independently thermally labile blocks and D is a poly(amic acid) block; and then to treat the A-D, A-D-A, or A-D-C block copolymer with an anhydride and a base to form the A-B, A-B-A, or A-B-C block copolymer.

Depolymerization/Repolymerization involves the selective depolymerization of a pre-formed polymer, followed by the repolymerization to incorporate the desired polyimide block. The initial polymer used typically consists of a thermally labile polymer. Under controlled conditions, the thermally labile block is selectively depolymerized, breaking the polymer into smaller fragments. The depolymerization can be achieved using various techniques such as thermal treatment or chemical reactions specific to the labile block. Once the desired depolymerization has occurred, the fragments are then subjected to a repolymerization reaction to incorporate the polyimide block. This repolymerization step involves the formation of polyimide linkages, typically through a polycondensation reaction or imidization process.

These and other methods enable the synthesis of block copolymers containing a thermally labile block and a polyimide block, providing control over the composition, molecular weight, and architecture of the copolymer. The resulting materials can exhibit unique thermal properties, processability, and tailored functionality, making them suitable for casting and forming the membranes described herein.

Choosing the appropriate blocks, as well as choosing the appropriate sizes of each block, can have an important impact on controlling not only the membrane strength but also the membrane pore size and pore uniformity. In some aspects, the block sizes are chosen to optimize the pore diameter of the membrane.

In some instances, the blocks each have a length (Mn) that can independently be about 50 to about 1000, about 100 to about 1000, about 200 to about 1000, about 300 to about 1000, about 400 to about 1000, about 50 to about 800, about 100 to about 800, about 200 to about 800, about 300 to about 800, about 400 to about 800, about 100 to about 500, about 150 to about 350, or any combination thereof. In some instances, the Mn is optimized to select the pore size. For example, by controlling the lengths of the thermally labile blocks it is one parameter to control the porosity and pore size.

In some instances, the blocks each have a molecular weight (Mw) that can independently be about 10 kDa to about 200 kDa, about 10 kDa to about 150 kDa, about 10 kDa to about 100 kDa, about 10 kDa to about 90 kDa, about 40 kDa to about 60 kDa, about 30 kDa to about 70 kDa, about 40 kDa to about 70 kDa, or about 30 kDa to about 80 kDa.

A block of PLA with a Mw from about 40 kDa to about 60 kDa, or from about 30 kDa to about 70 kDa, or from about 10 kDa to 90 kDa. A block of polyimide with a Mw from about 40 kDa to about 70 kDa, or from about 30 kDa to about 80 kDa, or from about 10 kDa to 100 kDa, from uncrosslinked to crosslinked.

### Casting Polymer Films

Casting polymer films is a widely used method for producing thin films with controlled thickness and desired properties. The process can involve the controlled pouring or spreading of a liquid polymer solution or dispersion onto a substrate, followed by the evaporation of the solvent, resulting in the formation of a solid film. Various parameters can be adjusted in polymer casting including the polymer concentration in the casting solution, the solvent selection, the casting method, the substrate and substrate preparation, the drying conditions, and any additives or processing aids. By adjusting these parameters, film thickness, surface morphology, mechanical properties, and other relevant attributes can be tailored to meet specific application requirements.

The concentration of the polymer in the casting solution can be an important parameter that affects the film's thickness, mechanical properties, and overall quality. Higher polymer concentrations generally result in thicker films. Adjusting the polymer concentration can be achieved by varying the ratio of polymer to solvent in the casting solution. Generally, polymer concentrations in casting solutions range from a few weight percent up to around 30 weight percent or higher. Increasing polymer concentration in the casting solution can lead to the formation of thicker films. Increasing polymer concentration can also lead to enhanced mechanical strength in the film due to the denser network of polymer chains. Decreasing polymer concentration in the casting solution can therefore lead to thinner films and increased film flexibility due to decreased polymer density and more pronounced polymer chain mobility.

The choice of solvent(s) in the casting solution influences the film's properties and drying kinetics. Solvents with different evaporation rates can be employed to control the film's drying time, which impacts the formation of defects such as pinholes or cracks. Adjusting the solvent composition and volatility can help achieve desired film quality and thickness. Organic solvents are frequently used in polymer casting due to their ability to dissolve a wide range of polymers. Some common organic solvents include acetone, ethanol, tetrahydrofuran, and dimethylformamide.

Acetone is a volatile solvent that evaporates quickly, leading to rapid drying. It is often used for fast-drying films and can result in films with good clarity and smoothness. Ethanol is a commonly used solvent that offers good solvating power for many polymers. It evaporates at a moderate rate, allowing for controlled drying and the formation of films with improved uniformity and reduced defects. Tetrahydrofuran (THF) is a versatile solvent suitable for many polymers. It has a relatively fast evaporation rate and can lead to films with good clarity and mechanical properties. Dimethylformamide (DMF) is a high-boiling solvent that evaporates slowly. It is often used for casting solutions requiring longer drying times. DMF can facilitate the formation of films with improved adhesion and mechanical properties.

To optimize solubility, viscosity, and drying characteristics, solvent mixtures are frequently used in casting solutions. By combining different solvents, it is possible to tailor the properties of the casting solution and film. Examples of common solvent mixtures include acetone and THF or DMF and methanol. Acetone/THF combines the fast-drying nature of acetone with the solvating power of THF, resulting in films with good properties and controlled drying rates. DMF/Methanol allows for controlled evaporation and improved film uniformity. Methanol aids in reducing the drying time and promotes the formation of smoother films.

The drying time of the casting solution can influence the film properties. Key impacts include film thickness, uniformity, mechanical properties and surface smoothness. Longer drying times generally lead to thicker films due to a greater amount of solvent evaporation. Controlling the drying time allows for precise control over film thickness. Proper drying time ensures controlled evaporation, which contributes to uniform solvent removal and even film formation. Inadequate drying time can result in uneven drying and the formation of defects like pinholes or cracks. The drying time can affect the polymer chain arrangement and morphology within the film. A longer drying time allows for more complete solvent removal and enhances the polymer chain packing, leading to improved mechanical properties such as strength and toughness. Longer drying time can also allow for greater phase segregation in block copolymers that are designed to self assemble into various domains. Proper drying time allows the film to form a smooth surface, as the solvent evaporates evenly. Insufficient drying time can result in rough surfaces or surface imperfections.

Different casting techniques can be employed to control the film thickness and quality. Blade coating, also known as knife coating or doctor blade coating, involves spreading the casting solution with a controlled-gap blade to achieve a uniform film thickness. Spin coating involves depositing a small amount of solution onto a rotating substrate, resulting in a thin and uniform film. Dip coating immerses the substrate into the casting solution and then withdraws it at a controlled speed, allowing for controlled film thickness.

The choice of substrate and proper surface preparation can play important factors in casting polymer films, as they impact adhesion, film quality, and overall performance. Suitable substrates can be chosen based on material compatibility, smoothness or flatness, or thermal stability. The substrate should typically be compatible with the casting process and the polymer being used. Common substrate materials include glass, silicon, polymers, metals, and ceramics. Compatibility ensures good adhesion and prevents undesired interactions or reactions between the substrate and the polymer. It is typically desired that the substrate have a smooth and flat surface to facilitate the formation of uniform and defect-free films. Smooth substrates minimize the risk of surface irregularities or roughness transferring onto the film. The substrate should exhibit sufficient thermal stability to withstand the casting process as well as any subsequent thermal treatment without undergoing deformation or degradation. This is particularly important when casting involves elevated temperatures or solvent exposure.

Preparation of the substrate surface can help ensure quality films. Proper cleaning of the substrate can remove contaminants, oils, dust, or residues that may affect film adhesion and quality. Common cleaning methods include solvent cleaning (e.g., using isopropyl alcohol), ultrasonic cleaning, or plasma cleaning. Surface activation treatments enhance the substrate's surface energy and promote adhesion between the substrate and the polymer. Methods such as corona treatment, plasma treatment, or flame treatment can modify the surface properties, increase wettability, and improve bonding.: In some cases, the substrate surface may undergo chemical modification to introduce specific functional groups that enhance adhesion or compatibility with the polymer. Chemical treatments can involve techniques like chemical etching, deposition of adhesion-promoting layers, or surface grafting of functional groups.

Additives are often incorporated into polymer casting solutions to modify film properties and improve specific characteristics. These additives can influence various film properties, such as mechanical strength, flexibility, adhesion, transparency, and thermal stability. Plasticizers are added to increase the flexibility and reduce the brittleness of the resulting film. Plasticizers act by reducing intermolecular forces, allowing for increased polymer chain mobility and improved film flexibility. Plasticizers enhance film elongation, reduce the glass transition temperature (Tg), and improve film toughness. However, excessive plasticizer content can lead to film softening or increased susceptibility to environmental factors. Surfactants are added to casting solutions to reduce surface tension and improve wetting and spreadability on the substrate. They facilitate the formation of a uniform and defect-free film. Surfactants help to improve the film's surface smoothness, reduce defects like pinholes or bubbles, and enhance the film's overall quality and appearance.

### Thermal Decomposition and Thermally Labile Blocks

The precursor films including the thermally labile blocks can be subjected to a heating treatment to decompose all or a portion of the thermally labile blocks. In some aspects, the thermally labile blocks are chosen based on the thermolysis temperature and/or the amount of gas produced during thermolysis and/or on how slowly or controllably the thermolysis can be completed. Through such a judicious selection of the thermally labile blocks and the heating protocol, the high quality polyimide films can be produced.

A chemical, a chemical moiety, or a polymer block, is labile if the chemical, a chemical moiety, or a polymer block can be removed by chemical, physical, or biological reaction. In an aspect, the term labile can mean thermolabile, in that the chemical, a chemical moiety, or a polymer block can be destroyed or decomposed by heat. In some aspects, the temperature required to decompose a polymer block (the thermolysis temperature) can be from about 150° C. to about 300° C., or from about 200° C. to about 300° C., or from about 250° C. to about 300° C., or from 100° C. to below 280° C.

A polymer block can be removed by a stepwise heating process, for example, by heating the diblock or triblock polymer to a first temperature, where it is held for a first period of time; subsequently heating to a second temperature wherein it is held for a second period of time; wherein the second temperature is greater than the first temperature; there can be from 2 to 8 temperatures and periods of time.

The thermolysis temperature of polylactide (PLA) can vary depending on its molecular weight, degree of crystallinity, and processing conditions, but generally, it ranges between 250-300° C. (482-572° F.). At this temperature range, PLA undergoes thermal degradation, and the polymer chains break down into their constituent monomers, lactic acid, and lactide. The degradation process of PLA is accompanied by the evolution of various degradation products, such as water, carbon dioxide, and other small molecules. The thermal degradation behavior of PLA is influenced by several factors, such as the presence of additives, the heating rate, and the processing conditions, and can impact the mechanical and thermal properties of the material.

The thermolysis temperature of PMMA (Poly(methyl methacrylate)) can vary depending on the molecular weight, degree of crosslinking, and other factors, but generally it ranges between 270-350° C. (518-662° F.). At this temperature range, PMMA decomposes into its constituent monomers, methyl methacrylate, and releases various degradation products such as carbon dioxide, methane, and small amounts of toxic fumes. The decomposition process of PMMA is exothermic, meaning it generates heat as it breaks down, and can potentially lead to thermal runaway if not carefully controlled.

Acrylic polymers with thermolysis temperatures below 270° C. are generally considered to be low-temperature thermoplastics, and they are used in applications where high-temperature resistance is not required. Polyethyl acrylate (PEA) is a soft, rubbery polymer that has a thermolysis temperature range of 150-180° C. Poly(n-butyl acrylate) (PBA) is a soft, flexible polymer that has a thermolysis temperature range of 200-230° C.

Poly(methyl acrylate) (PMA) is a soft, low glass transition temperature (Tg) polymer that has a thermolysis temperature range of 220-250° C. Poly(2-hydroxyethyl acrylate) (PHEA) is a hydrophilic polymer that has a thermolysis temperature range of 180-220° C.

The thermolysis temperature of polystyrene (PS) can vary depending on the molecular weight, degree of crystallinity, and processing conditions, but generally, it ranges between 270-370° C. (518-698° F.). At this temperature range, PS undergoes thermal degradation, and the polymer chains break down into their constituent monomers, styrene. The degradation process of PS is accompanied by the evolution of various degradation products, such as benzene, toluene, and other small molecules. The thermal degradation behavior of PS is influenced by several factors, such as the presence of additives, the heating rate, and the processing conditions, and can impact the mechanical and thermal properties of the material.

Styrenic polymers with thermolysis temperatures below 270° C. are generally considered to be low-temperature thermoplastics, and they are used in applications where high-temperature resistance is not required. Polystyrene (PS) is a transparent, rigid polymer that has a thermolysis temperature range of 240-270° C. Styrene-acrylonitrile (SAN) is a transparent, rigid polymer that has a thermolysis temperature range of 230-260° C. Styrene-butadiene-styrene (SBS) is a thermoplastic elastomer that has a thermolysis temperature range of 200-240° C. Styrene-ethylene/butylene-styrene (SEBS) is a thermoplastic elastomer that has a thermolysis temperature range of 200-240° C.

Vinyl polymers with thermolysis temperatures below 270° C. are generally considered to be low-temperature thermoplastics, and they are used in applications where high-temperature resistance is not required. Polyvinyl alcohol (PVA) is a water-soluble polymer that has a thermolysis temperature range of 200-250° C. Polyvinyl acetate (PVAc) is a flexible, rubbery polymer that has a thermolysis temperature range of 200-230° C. Polyvinyl chloride (PVC) is a rigid, thermoplastic polymer that has a thermolysis temperature range of 200-240° C. Polyvinylidene chloride (PVDC) is a barrier polymer that has a thermolysis temperature range of 200-240° C.

The thermolysis temperature of poly(α-methyl styrene) (PAMS) can vary depending on its molecular weight, degree of crystallinity, and processing conditions, but generally, it ranges between 290-360° C. (554-680° F.). At this temperature range, PAMS undergoes thermal degradation, and the polymer chains break down into their constituent monomers, α-methyl styrene. The degradation process of PAMS is accompanied by the evolution of various degradation products, such as methane, ethylene, and other small molecules. The thermal degradation behavior of PAMS is influenced by several factors, such as the presence of additives, the heating rate, and the processing conditions, and can impact the mechanical and thermal properties of the material.

The thermolysis temperature of polycaprolactone (PCL) can vary depending on its molecular weight, degree of crystallinity, and processing conditions, but generally, it ranges between 220-350° C. (428-662° F.). At this temperature range, PCL undergoes thermal degradation, and the polymer chains break down into their constituent monomers, caprolactone. The degradation process of PCL is accompanied by the evolution of various degradation products, such as carbon dioxide and small molecules. The thermal degradation behavior of PCL is influenced by several factors, such as the presence of additives, the heating rate, and the processing conditions, and can impact the mechanical and thermal properties of the material.

Polyesters with thermolysis temperatures below 270° C. are generally considered to be low-temperature thermoplastics, and they are used in applications where high-temperature resistance is not required. Polyethylene terephthalate (PET) is a transparent, rigid polymer that has a thermolysis temperature range of 250-270° C. Polybutylene adipate-co-terephthalate (PBAT) is a flexible, biodegradable polymer that has a thermolysis temperature range of 220-260° C. Polytrimethylene terephthalate (PTT) is a flexible, biodegradable polymer that has a thermolysis temperature range of 240-260° C. Polyethylene succinate (PES) is a flexible, biodegradable polymer that has a thermolysis temperature range of 200-230° C.

The thermolysis temperature of poly(ethylene oxide) (PEO) can vary depending on its molecular weight, degree of crystallinity, and processing conditions, but generally, it ranges between 280-340° C. (536-644° F.). At this temperature range, PEO undergoes thermal degradation, and the polymer chains break down into their constituent monomers, ethylene oxide. The degradation process of PEO is accompanied by the evolution of various degradation products, such as carbon dioxide, carbon monoxide, and water. The thermal degradation behavior of PEO is influenced by several factors, such as the presence of additives, the heating rate, and the processing conditions, and can impact the mechanical and thermal properties of the material. PEO is a highly water-soluble polymer and is commonly used in applications such as pharmaceuticals, cosmetics, and lubricants.

The thermolysis temperature of poly(propylene oxide) (PPO) can vary depending on its molecular weight, degree of crystallinity, and processing conditions, but generally, it ranges between 250-300° C. (482-572° F.). At this temperature range, PPO undergoes thermal degradation, and the polymer chains break down into their constituent monomers, propylene oxide. The degradation process of PPO is accompanied by the evolution of various degradation products, such as water, propylene, and other small molecules. The thermal degradation behavior of PPO is influenced by several factors, such as the presence of additives, the heating rate, and the processing conditions, and can impact the mechanical and thermal properties of the material. PPO is a flexible, water-insoluble polymer that is used in a variety of applications such as surfactants, lubricants, and coatings.

Polyethers with thermolysis temperatures below 270° C. are generally considered to be low-temperature thermoplastics, and they are used in applications where high-temperature resistance is not required. Polyethylene oxide (PEO) is a water-soluble polymer that has a thermolysis temperature range of 280-340° C. Polypropylene oxide (PPO) is a water-insoluble polymer that has a thermolysis temperature range of 250-300° C. Poly(tetramethylene ether)glycol (PTMEG) is a flexible, low-temperature polymer that has a thermolysis temperature range of 200-250° C. Poly(ethylene-co-propylene glycol) (PPEG) is a block copolymer that has a thermolysis temperature range of 220-250° C.

The heating protocol can be chosen based on the thermolysis temperature of the thermally labile blocks. In some aspects, the temperature to which the precursor film is heated is about 100° C. to about 400° C., about 100° C. to about 300° C., about 150° C. to about 350° C., about 150° C. to about 300° C. Is some aspects the thermally labile block has a thermolysis temperature of about 270° C., about 250° C., about 230° C., about 200° C., or less.

In some aspects, the heating is performed over one or more time intervals. For example, it can be advantageous in some instances to gradually increase the temperature over multiple time intervals. In some instances, the time interval comprises from 2 to 10 time intervals, and the elevated temperature comprises a different elevated temperature for each of the 2 to 10 time intervals. For example, there can be 2, 3, 4, 5, 6, 7, 8, 9, or 10 time intervals each with a specific temperature that can be the same or different. In some instances, the time interval or each of the separate time intervals can comprise about thirty minutes to about 48 hours, about 30 minutes to about 3 hours, or about 12 hours to about 36 hours.

### Polyimide Membranes

In various aspects, mesoporous polyimide membranes are provided having a plurality of mesopores. The mesoporous polyimide membranes can have a first surface and a second surface opposite the first surface, wherein the plurality of mesopores extend from the first surface to the second surface so that there is fluid communication from the first surface to the second surface. The plurality of mesopores can be isoporous and with an average pore size that can be controlled using methods described herein. The mesoporous polyimide membranes are useful as separators in electrochemical devices such as alkali metal batteries, where the controllable, uniform porosity and the strength of the membranes provide several advantages for suppressing dendrite growth and preventing short circuiting of the battery.

The storage modulus of the membranes at ambient temperature (e.g., about 25° C.) is typically from about 1.5 gigapascals (GPa) to about 5 GPa, at or from about 1.5 GPa to about 4 GPa, or from about 1.5 GPa to about 2.5 GPa, or from about 1.5 GPa to about 2 GPa.

Film or Membrane Thickness: Generally, the membrane thickness can be that which functions best as a separator in an electrical device. The thickness can be from about 5 microns to about 50 microns (μm), or from about 5 μm to about 40 μm, or from about 10 μm to about 40 μm, or from about 10 μm to about 30 μm, or from about 15 μm to about 30 μm, or from about 20 μm to about 30 μm, or from about 20 μm to about 25 μm.

In an aspect of the disclosure, mesopores in a film generally are from about 2 nm to about 50 nm width pores as measured by nitrogen isothermal adsorption at 77° K. and 1 atm pressure. Generally, the mesopores extend from the first surface to the second surface of the film so that there is fluid communication from the first surface to the second surface.

Typically, the median mesopore width of a set of mesopores can be from about 2 nm to about 50 nm, or from about 2 nm to about 40 nm, or from about 5 nm to about 20 nm, or from about 10 nm to about 20 nm, or from 10 nm to 40 nm, or from about 20 nm to 40 nm, or from about 15 nm to 25 nm, or from about 20 nm to about 30 nm. A film can be said to be mesoporous if from about 80% to about 100%, or from 85% to about 95%, or from about 90% to 100% of the pores in the film are mesopores.

### Electrochemical Devices

Electrochemical devices that use a separator membrane are commonly found in various applications, including batteries, fuel cells, supercapacitors, and electrolyzers. The separator membrane serves as a physical barrier between the positive and negative electrodes, preventing direct contact while allowing the transport of ions or charge carriers.

In alkali metal batteries such as lithium ion batteries, the separator membrane is typically a microporous polymer film placed between the positive and negative electrodes. The separator acts as a barrier to prevent short circuits while enabling the passage of alkali metal ions. In Polymer Electrolyte Membrane Fuel Cells (PEMFC), a thin polymer electrolyte membrane is used as a separator. The membrane is typically sandwiched between two electrode layers, forming a three-layer structure known as the membrane electrode assembly (MEA). In Redox Flow Batteries (RFB), a separator membrane is used to separate the positive and negative electrolyte solutions. The separator needs to allow the selective transport of ions while minimizing crossover between the two electrolytes. In supercapacitors, a separator membrane is used to physically separate the positive and negative electrodes while allowing the transport of ions.

In some aspects, electrochemical devices are provided that utilize the polyimide membranes as described herein. The electrochemical device can include an anode; a cathode; an electrolyte, and an electrochemical cell separator material formed from one of the polyimide membranes described herein. The electrochemical cell separator can be installed, located, or mounted between the anode and the cathode.

The specific structure such as preferred thickness or pore size and composition of the separator membranes can depend on the electrochemical device's requirements, including ion selectivity, mechanical strength, thermal stability, and compatibility with the electrolyte.

In some aspects, the electrochemical device is an alkali metal battery such as a lithium ion battery, a sodium ion battery, or a potassium ion battery. The specific choice of the anode, cathode, and electrolyte material can depend on which alkali metal is being used. Likewise, the preferred polyimide membrane can be chosen based on the choice of alkali metal as well as the choice of the other parts of the battery such as the anode, cathode, and the electrolyte. In some instances, the size of dendrites formed depend not only on the choice of metal but on the geometry and choice of other materials in the battery. The polyimide membrane can be designed to have the optimal modus and the optimal pore size for each battery. In some instances, the choice of pore size is such that the pore size is smaller than the average dendrite size in the alkali metal battery.

There are several cathode materials used in lithium-ion batteries, each with its own unique properties and characteristics. Lithium Cobalt Oxide (LiCoO2 is one of the earliest and most widely used cathode materials. It offers high energy density and good cycling stability, making it suitable for applications such as portable electronics. Lithium Manganese Oxide (LiMn2O4) also known as spinel, is a cathode material that provides good thermal stability, high power output, and relatively low cost. However, it has a lower energy density compared to other materials. Lithium Nickel Cobalt Aluminum Oxide (NCA) cathodes offer a high energy density and good power capability. They are commonly used in electric vehicle (EV) applications due to their ability to deliver high current and provide long-range driving. Lithium Iron Phosphate (LiFePO4) is known for its excellent thermal stability, long cycle life, and enhanced safety compared to other cathode materials. It has lower energy density but is favored for applications where safety and longevity are critical, such as power tools and electric buses. Lithium Nickel Manganese Cobalt Oxide (NMC) cathodes combine nickel, manganese, and cobalt, offering a balance between energy density, power capability, and cost. They are commonly used in both portable electronics and electric vehicles. Lithium Nickel Cobalt Oxide (LiNiCoO2) cathode material, often referred to as NCO, provides high energy density and good cycling stability. It is used in various applications, including power tools and electronic devices. Lithium Vanadium Oxide (LiV₂O₅) cathodes exhibit excellent rate capability and long cycle life. They are commonly used in high-power applications, such as power tools and hybrid electric vehicles (HEVs).

Commonly used anode materials in lithium-ion batteries include graphite, silicon, lithium titanate, and lithium metal. Graphite is the most widely used anode material in lithium-ion batteries. It offers good cycling stability, high Coulombic efficiency, and relatively low cost. Graphite anodes work through the intercalation of lithium ions between the graphite layers. Silicon has a high theoretical capacity for lithium storage, making it an attractive anode material. It can store about 10 times more lithium than graphite. However, silicon experiences significant volume expansion during lithiation, leading to mechanical degradation. Researchers are actively exploring strategies to mitigate this issue and enhance the cycling stability of silicon anodes. Lithium titanate (Li4Ti5O12) anodes provide excellent stability, long cycle life, and high power capability. They have a relatively low operating voltage, but they offer improved safety and are less prone to lithium plating compared to other anode materials. Lithium metal has the highest theoretical capacity among anode materials. However, its practical application faces challenges related to dendrite formation, unstable solid-electrolyte interface (SEI), and safety concerns. In some instances, the membrane separators described herein will allow for wider use and adoption of lithium metal as the anode material, thereby allowing for higher capacity lithium batteries. Various alloying materials, such as tin (Sn), have been studied as anode materials to improve energy density and cycling stability. Alloying materials can undergo electrochemical reactions with lithium to store and release energy efficiently.

Liquid electrolytes used in lithium-ion batteries typically include lithium salts dissolved in organic solvents. The most commonly used liquid electrolyte material in lithium-ion batteries is lithium hexafluorophosphate (LiPFs). It provides good ionic conductivity and stability in organic solvents. Other lithium salts that have been used or studied as alternatives to LiPF₆ include lithium bis(trifluoromethanesulfonyl)imide (LiTFSI) and lithium perfluorosulfonate (LiPFOS). The above-mentioned lithium salts are typically dissolved in a mixture of organic solvents, such as ethylene carbonate (EC), dimethyl carbonate (DMC), diethyl carbonate (DEC), ethyl methyl carbonate (EMC), propylene carbonate (PC), mixtures thereof, and mixtures thereof with one or more additional solvents. These solvents are chosen based on their ability to dissolve lithium salts and provide sufficient ionic conductivity for the battery's operation.

While sodium-ion batteries are still in the research and development phase compared to lithium-ion batteries, they offer tremendous potential in terms of the cost, safety, and scalability given the overall abundance of sodium. Several cathode materials have been investigated for sodium-ion battery applications including sodium cobalt oxide, sodium nickel cobalt manganese oxide, sodium iron phosphate, sodium manganese oxide, Prussian blue and analogs thereof, P2-type Na layered oxides, and a combination thereof.

Suitable anode materials for sodium ion batteries can include hard carbon, graphite, tin-based alloys, sodium titanate, sodium metal, and a combination thereof.

In some instances, the electrolyte for a sodium ion battery includes a sodium salt dissolved in an organic solvent. The sodium salt can be selected from the group consisting of sodium hexafluorophosphate, sodium bis(trifluoromethanesulfonyl)imide, sodium perchlorate, combinations thereof, and combinations thereof with one or more additional salts. The organic solvent can include ethylene carbonate (EC), dimethyl carbonate (DMC), diethyl carbonate (DEC), ethyl methyl carbonate (EMC), propylene carbonate (PC), mixtures thereof, and mixtures thereof with one or more additional solvents.

Potassium ion batteries are also still in the early stages of development compare to the lithium ion battery analogues. In addition to the overall abundance, the promise of potassium ion batteries includes potential to achieve high energy densities, similar to or even exceeding those of lithium batteries, and potentially higher charge-discharge rates compared to lithium.

Anode materials for potassium ion batteries can include an graphite, potassium titanium oxide, potassium vanadium oxides, tin-based alloys, and a combination thereof. Suitable cathodes for potassium ion batteries can include potassium manganese oxide, Prussian blue and analogs thereof, polyanion based materials such as potassium iron phosphate, layered transition metal oxides such as potassium nickel oxide, and a combination thereof. The electrolyte can likewise include a potassium salt dissolved in an organic solvent. Potassium salts can include potassium hexafluorophosphate, potassium bis(trifluoromethanesulfonyl)imide, combinations thereof, and combinations thereof with one or more additional salts. The organic solvent can include ethylene carbonate (EC), dimethyl carbonate (DMC), diethyl carbonate (DEC), ethyl methyl carbonate (EMC), propylene carbonate (PC), mixtures thereof, and mixtures thereof with one or more additional solvents.

### Measurement Protocols

Various systems and techniques can be used to characterize the electrochemical device performance and the properties of the polyimide membranes. Those skilled in the art will readily be able to understand the various protocols described herein and, as needed, to make adjustments to accommodate measurements for a range of polyimide membranes and a variety of electrochemical devices. I

In some aspects, the polymer membranes are characterized using dynamic mechanical analysis (DMA). DMA is a technique used to evaluate the mechanical properties and behavior of polymer membranes and other materials under dynamic loading conditions. DMA measures the response of a material to an applied oscillatory stress or strain as a function of time, temperature, or frequency. It provides valuable information about the viscoelastic properties, such as stiffness, damping, and the glass transition temperature (Tg), which are essential for understanding the mechanical performance and behavior of polymer membranes.

The DMA apparatus typically consists of a sample holder where the polymer membrane is clamped between two grips or fixtures. The sample is then subjected to an oscillatory stress or strain while being subjected to controlled temperature conditions. The applied stress or strain can be sinusoidal, triangular, or any other defined waveform.

During the DMA measurement, the instrument records the stress and strain response of the polymer membrane as a function of temperature or frequency. From these measurements, various mechanical properties can be obtained such as the storage modulus, the loss modulus, the loss tangent, and the glass transition temperature.

Storage Modulus (E) represents the material's ability to store elastic energy and is a measure of its stiffness or rigidity. The storage modulus provides information about the material's resistance to deformation under an applied stress.

Loss Modulus (E″) represents the material's ability to dissipate energy and is related to the material's damping or viscoelastic behavior. The loss modulus indicates the energy dissipated as heat during cyclic loading.

Loss Tangent (tanδ) is the ratio of the loss modulus to the storage modulus and represents the material's damping characteristics. A higher loss tangent indicates a higher degree of energy dissipation and viscoelastic behavior.

Glass Transition Temperature (Tg) can also be determined by analyzing the changes in the storage modulus and loss modulus with temperature. The Tg represents the temperature at which a polymer transitions from a glassy state to a rubbery state, affecting its mechanical properties.

By analyzing the mechanical properties obtained from DMA measurements, researchers can assess the suitability of polymer membranes for specific applications. DMA is widely used in the characterization of membranes used in various fields, including filtration, gas separation, fuel cells, sensors, and many other applications that require understanding the viscoelastic behavior and mechanical response of polymer materials.

The storage modulus of the membrane can be determined by the Storage Modulus Protocol. The Storage Modulus Protocol comprises the steps of
i. Preparing the polymer sample in the desired shape and size suitable for DMA analysis;
ii. Mounting the sample into the sample holder of the TA Q800 DMA analyzer available from TA Instruments,
iii. Performing stress and strain measurements at one or more temperatures from room temperature to about 300° C. and using a heating rate between 1° C. and 10° C. per minute at a frequency between about 1 to about 10 Hz, and a strain amplitude of about 0.01% to 1% strain
iv. Computing the complex modulus from the recorded stress and strain data,
v. Extracting the storage modulus for each temperature as the real part of the complex modulus.

Nitrogen Adsorption Protocol The Nitrogen Adsorption Protocol typically involves determining the accessible surface area of the membrane and the pore size distribution according to the following steps:
i. preparing the polymer membrane sample by ensuring it is clean, free from contaminants, and properly dried if necessary;
ii. accurately weighing the membrane sample;
iii. installing the sample into the Nitrogen adsorption cell;
iv. outgassing the cell at a temperature of about 200-300° C. for several hours to remove any adsorbed gases or moisture that may interfere with the measurement;
v. transferring the sample cell containing the polymer membrane sample to the analysis chamber or instrument capable of measuring nitrogen adsorption;
vi. cooling the sample cell and the polymer membrane to 77 K using liquid nitrogen or a cryogenic cooling system.
vii. applying a controlled pressure of 1 atmosphere of nitrogen gas to the sample cell and allow the nitrogen to adsorb onto the polymer membrane surface;
viii. measuring the volume of nitrogen gas adsorbed as a function of pressure using a pressure transducer or other appropriate measurement device; and
ix. computing the pore size using the Brunauer/Emmett/Teller (BET) technique.

Scanning Electron Microscopy: is performed by persons of ordinary skill in the art using benchtop equipment, such as a LEO (Zeiss) 1550 high-spatial resolution SEM using a Schottky field emission (FEG) electron source, capable of resolution in 1-5 nm size range using an in-lens SED. The instrument can be used for high-resolution imaging of surfaces, qualitative assessment of the distribution of elements (by EDS), submicron structure analysis, and determination of crystal orientation and crystalline texture (by EBSD).

### ASPECTS

The disclosure will be better understood by reading the following numbered aspects, which should not be confused with the claims. In some instances, one or more aspects can be combined or combined with aspects described elsewhere in the disclosure or aspects from the examples without deviating from the invention. The following listing of exemplary aspects supports and is supported by the disclosure provided.
Aspect 1. A method of preparing a mesoporous polyimide membrane comprising a) casting an A-B, A-B-A, or A-B-C block copolymer on a substrate to form a precursor, heating the precursor film to a temperature from about 100° C. to about 300° C. for a time interval to form the polyimide membrane; wherein the mesoporous polyimide membrane comprises a plurality of mesopores wherein a median diameter of the mesopores is from about 5 nm to about 20 nm as measured by the Nitrogen Sorption Protocol. A and C are each independently thermally labile blocks and B is a polyimide block.
Aspect 2. The method of aspect 1, further comprising prior to the casting step preparing an A-D, A-D-A, or A-D-C block copolymer, wherein A and C are each independently thermally labile blocks and D is a poly(amic acid) block; and treating the A-D, A-D-A, or A-D-C block copolymer with an anhydride and a base to form the A-B, A-B-A, or A-B-C block copolymer.
Aspect 3. The method of any one of the foregoing aspects, wherein the thermally labile blocks are each independently selected from the group consisting of a polyacrylate, a vinyl polymer, a styrenic polymer, a polyester, and a polyether.
Aspect 4. The method of any one of the foregoing aspects, further comprising prior to the casting step preparing a polylactide-b-poly(amic acid)-b-polylactide (PLA-b-PAA-b-PLA) triblock copolymer; and treating the PLA-b-PAA-b-PLA triblock copolymer with an anhydride and a base to form the A-B-A block copolymer.
Aspect 5. The method of any one of the foregoing aspects, further comprising prior to the casting step preparing a polylactide-b-poly(amic acid) (PLA-b-PAA) diblock copolymer; and treating the PLA-b-PAA diblock copolymer with an anhydride and a base to form the A-B block copolymer.
Aspect 6. The method of any one of the foregoing aspects wherein one or both of the thermally labile blocks are polyacrylates selected from the group consisting of a polyethyl acrylate (PEA), a poly(n-butyl acrylate) (PBA), a poly(methyl acrylate) (PMA), a poly(methyl methacrylate) (PMMA), a poly(2-hydroxyethyl acrylate) (PHEA), and copolymers thereof.
Aspect 7. The method of any one of the foregoing aspects, wherein one or both of the thermally labile blocks are vinyl polymers selected from the group consisting of a polyvinyl alcohol (PVA), a polyvinyl acetate (PVAc), a polyvinyl chloride (PVC), a polyvinylidine chloride (PVDC), and copolymers thereof.
Aspect 8. The method of any one of the foregoing aspects, wherein one or both of the thermally labile blocks are styrenic polymers selected from the group consisting of polystyrene (PS), poly(styrene-acrylonitrile) (SAN), poly(styrene-butadiene-styrene) (SBS), poly(styrene-ethylene/butyliene-styrene) (SEBS), and copolymers thereof.
Aspect 9. The method of any one of the foregoing aspects, wherein one or both of the thermally labile blocks are polyesters selected from the group consisting of a polyethylene terephthalate (PET), a polybutylene adipate-co-terephthalate (PBAT), a polytrimethylene terephthalate (PTT), a polyethylene succinate (PES), and copolymers thereof.
Aspect 10. The method of any one of the foregoing aspects, wherein one or both of the thermally labile blocks are polyethers selected from the group consisting of a polyethylene oxide (PEO), a polypropylene oxide (PPO), a poly(tetramethylene ether)glycol (PTMEG), a poly(ethylene-co-propylene glycol) (PPEG), and copolymers thereof.
Aspect 11. The method of any one of the foregoing aspects, wherein the thermally labile blocks comprise polylactide.
Aspect 12. The method of any one of the foregoing aspects, wherein the thermally labile block has a thermolysis temperature of about 270° C., about 250° C., about 230° C., about 200° C., or less.
Aspect 13. The method of any one of the foregoing aspects, wherein the mesoporous polyimide membrane has a storage modulus of from 1.5 to 2.5 GPa as measured by the Storage Modulus Protocol.
Aspect 14. The method of any one of the foregoing aspects, wherein a median pore width of the mesopores is from about 10 nm to about 40 nm.
Aspect 15. The method of any one of the foregoing aspects, wherein the median pore width is from about 20 nm to about 30 nm.
Aspect 16. The method of any one of the foregoing aspects, wherein the membrane has a thickness of from about 5 to about 50 microns.
Aspect 17. The method of any one of the foregoing aspects, wherein the mesopores are substantially isoporous.
Aspect 18. The method of any one of the foregoing aspects, wherein the time interval comprises from 2 to 10 time intervals, and wherein the elevated temperature comprises a different elevated temperature for each of the 2 to 10 time intervals.
Aspect 19. The method of any one of the foregoing aspects, wherein the time interval comprises about thirty minutes to about 48 hours, about 30 minutes to about 3 hours, or about 12 hours to about 36 hours.
Aspect 20. The method of any one of the foregoing aspects, wherein the temperature is from about 100° C. to below 280° C.
Aspect 21. A mesoporous polyimide membrane prepared according to of any one of the foregoing aspects.
Aspect 22. A mesoporous polyimide membrane comprising a polyimide membrane having a plurality of mesopores, wherein a median diameter of the mesopores is from about 5 nm to about 20 nm as measured by the Nitrogen Sorption Protocol, and wherein the mesopores are isoporous.
Aspect 23. The mesoporous polyimide membrane of any one of the foregoing aspects, wherein the mesoporous polyimide membrane has a storage modulus of from 1.5 to 5 GPa as measured by the Storage Modulus Protocol.
Aspect 24. The mesoporous polyimide membrane of claim 22 wherein the median diameter of the mesopores is from about 10 nm to about 40 nm.
Aspect 25. The mesoporous polyimide membrane of claim 22 wherein the median diameter of the mesopores is from about 20 nm to about 30 nm.
Aspect 26. The mesoporous polyimide membrane of claim 22 wherein the membrane thickness is from about 10 to about 40 microns.
Aspect 27. The mesoporous polyimide membrane of claim 22 wherein the membrane thickness is from about 15 to about 30 microns.
Aspect 28. The mesoporous polyimide membrane of claim 22 wherein the membrane thickness is from about 20 to about 25 microns.
Aspect 29. An electrochemical cell separator material comprising the mesoporous polyimide membrane of any one of the foregoing aspects.
Aspect 30. An electrochemical device comprising: (a) an anode; (b) a cathode; (c) the electrochemical cell separator material of any one of the foregoing aspects mounted between the anode and the cathode; and (d) an electrolyte.
Aspect 31. The electrochemical device of any one of the foregoing aspects wherein the anode comprises an anode stack comprising an anodic current collector; wherein the cathode comprises a cathode stack comprising a cathodic current collector; and wherein the electrochemical device is a battery, a capacitor, a supercapacitor, an electrolyzer, or a fuel cell.
Aspect 32. The electrochemical device of any one of the foregoing aspects wherein the electrochemical device is a lithium ion battery.
Aspect 33. The electrochemical device of any one of the foregoing aspects wherein the anode is selected from the group consisting of graphite, lithium titanate, silicon, lithium metal, other alloying metals such as tin, and a combination thereof.
Aspect 34. The electrochemical device of any one of the foregoing aspects wherein the graphite is a lithium-ion intercalation graphite.
Aspect 35. The electrochemical device of any one of the foregoing aspects wherein the cathode is selected from the group consisting of lithium cobalt oxide, lithium manganese oxide, lithium nickel cobalt aluminum oxide, lithium iron phosphate, lithium nickel manganese cobalt oxide, lithium nickel cobalt oxide, lithium vanadium oxide, and a combination thereof.
Aspect 36. The electrochemical device of any one of the foregoing aspects wherein the electrolyte is a liquid at standard temperature and pressure.
Aspect 37. The electrochemical device of any one of the foregoing aspects wherein the electrolyte comprises a lithium salt dissolved in an organic solvent.
Aspect 38. The electrochemical device of any one of the foregoing aspects wherein the lithium salt is selected from the group consisting of lithium hexafluorophosphate, lithium bis(trifluoromethanesulfonyl)imide, lithium perfluorosulfonate, combinations thereof, and combinations thereof with one or more additional salts.
Aspect 39. The electrochemical device of any one of the foregoing aspects wherein the organic solvent is selected from the group consisting of ethylene carbonate (EC), dimethyl carbonate (DMC), diethyl carbonate (DEC), ethyl methyl carbonate (EMC), propylene carbonate (PC), mixtures thereof, and mixtures thereof with one or more additional solvents.
Aspect 40. The electrochemical device of any one of the foregoing aspects wherein the electrochemical device is a sodium ion battery.
Aspect 41. The electrochemical device of any one of the foregoing aspects wherein the anode is selected from the group consisting of hard carbon, graphite, tin-based alloys, sodium titanate, sodium metal, and a combination thereof.
Aspect 42. The electrochemical device of any one of the foregoing aspects wherein the cathode is selected from the group consisting of sodium cobalt oxide, sodium nickel cobalt manganese oxide, sodium iron phosphate, sodium manganese oxide, Prussian blue and analogs thereof, P2-type Na layered oxides, and a combination thereof.
Aspect 43. The electrochemical device of any one of the foregoing aspects wherein the electrolyte is a liquid at standard temperature and pressure.
Aspect 44. The electrochemical device of any one of the foregoing aspects wherein the electrolyte comprises a sodium salt dissolved in an organic solvent.
Aspect 45. The electrochemical device of any one of the foregoing aspects wherein the sodium salt is selected from the group consisting of sodium hexafluorophosphate, sodium bis(trifluoromethanesulfonyl)imide, sodium perchlorate, combinations thereof, and combinations thereof with one or more additional salts.
Aspect 46. The electrochemical device of any one of the foregoing aspects wherein the organic solvent is selected from the group consisting of ethylene carbonate (EC), dimethyl carbonate (DMC), diethyl carbonate (DEC), ethyl methyl carbonate (EMC), propylene carbonate (PC), mixtures thereof, and mixtures thereof with one or more additional solvents.
Aspect 47. The electrochemical device of any one of the foregoing aspects wherein the electrochemical device is a potassium ion battery.
Aspect 48. The electrochemical device of any one of the foregoing aspects wherein the anode is selected from the group consisting of graphite, potassium titanium oxide, potassium vanadium oxides, tin-based alloys, and a combination thereof.
Aspect 49. The electrochemical device of any one of the foregoing aspects wherein the graphite is a potassium intercalation graphite.
Aspect 50. The electrochemical device of any one of the foregoing aspects wherein the cathode is selected from the group consisting of potassium manganese oxide, Prussian blue and analogs thereof, polyanion based materials such as potassium iron phosphate, layered transition metal oxides such as potassium nickel oxide, and a combination thereof.
Aspect 51. The electrochemical device of any one of the foregoing aspects wherein the electrolyte is a liquid at standard temperature and pressure.
Aspect 52. The electrochemical device of any one of the foregoing aspects wherein the electrolyte comprises a potassium salt dissolved in an organic solvent.
Aspect 53. The electrochemical device of any one of the foregoing aspects wherein the potassium salt is selected from the group consisting of potassium hexafluorophosphate, potassium bis(trifluoromethanesulfonyl)imide, combinations thereof, and combinations thereof with one or more additional salts.
Aspect 54. The electrochemical device of any one of the foregoing aspects wherein the organic solvent is selected from the group consisting of ethylene carbonate (EC), dimethyl carbonate (DMC), diethyl carbonate (DEC), ethyl methyl carbonate (EMC), propylene carbonate (PC), mixtures thereof, and mixtures thereof with one or more additional solvents.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

### Experimental Methods

### Chemicals

D,L-Lactide was recrystallized in ethyl acetate before use as follows. D,L-Lactide (10.0 g, Sigma-Aldrich) was dissolved in ethyl acetate (15.0 mL, Fisher Scientific) at 75° C. and stored at −4° C. for 1 h. Afterward, pure white lactide crystals were collected via vacuum filtration and dried at reduced pressure overnight. 3-(Boc-amino)-1-propanol (Sigma-Aldrich) was heated at 120° C. under a reduced pressure for 2 h to remove moisture and then stored over 4 A molecular sieves. Chloroform (Fisher Scientific) was stirred with CaH2 (Sigma-Aldrich) overnight and distilled before use. 1,8-Diazabicyclo[5.4.0]undec-7-ene (DBU), dichloromethane (DCM), trifluoroacetic acid (TFA), sodium bicarbonate, anhydrous dimethyl sulfoxide (DMSO), pyromellitic dianhydride (PMDA), 4,4′-oxydianiline (oDA), benzoyl chloride, acetic anhydride, pyridine, and ninhydrin were purchased from Sigma-Aldrich and used as received. Deuterated chloroform (CDCl3) and DMSO (DMSO-d6) were purchased from Cambridge Isotope Laboratories. LiPF6 in EC/DEC (1 M, Sigma-Aldrich) was utilized as the liquid electrolyte. In battery tests, LiFePO4 coated on aluminum foil (120 g/m2, 68 μm coating thickness, MTI corporation) was employed as the cathode, and lithium foil (0.20 mm thickness, Signa-Aldrich) as the anode. Battery cases, spacers, and springs (MTI corporation) were cleaned via sonication in a mixture of acetone/isopropanol (v:v=1:1) for 1 h and dried at 80° C. overnight. The polypropylene/polyethylene/polypropylene (PP/PE/PP) trilayer separators were purchased from Celgard, LLC.

### Instrumentation

Proton nuclear magnetic resonance (1H NMR) spectra were collected in CDCl3 or DMSO-d6 on a 400 MHz Varian Unity. Thermal gravimetric analysis (TGA) was conducted on a TGA 5500 (TA instrument) in the air. Fourier transform infrared spectroscopy (FT-IR) was performed on a Thermo Scientific Nicolet iS5 spectrometer with an iD7 ATR accessory. Nitrogen adsorption was performed on a Micromeritics 3Flex Adsorption Analyzer. Scanning electron microscopy (SEM) was conducted on a LEO Zeiss 1550. Dynamic mechanical analysis (DMA) was performed on a TA Q800 instrument. Oxygen plasma etching was conducted in a South Bay Technology PC-2000 using a forward power of 60 W. Coin cells were crimped on an MTI MSK-160 E. Electrochemical Impedance Spectroscopy (EIS) was performed on a PARSTAT 4000, Princeton Applied Research-AMETEK. The lithium-metal batteries and lithium/lithium batteries were tested on a Neware BTS4000.

### Polymerization of Boc-Terminated Polylactide (Boc-PLA).

To a 100-mL Schlenk tube, D,L-lactide (8.50 g) and 3-(Boc-amino)-1-propanol (18.3 mg) were dissolved in anhydrous chloroform (60.0 mL). The resulting solution was degassed with three freeze-pump-thaw cycles. Afterward, DBU (15.9 mg) was added to the solution in an argon-filled glovebox. The resulting solution was stirred at room temperature for 1 h. The polymerization was terminated by adding benzoyl chloride (30.0 mg) and stirring for another 1.5 h. Subsequently, the solution was poured into chilled methanol (300.0 mL). The white precipitates were collected as the product via vacuum filtration and then dried at 80° C. overnight in vacuo.

### Synthesis of Amine-Terminated PLA (PLA-NH2).

Boc-PLA (4.00 g) was dissolved in a mixture of DCM and TFA (v:v=1:1, 40.0 mL in total) and reacted overnight. Afterward, the solvents were removed on a rotary evaporator. The resulting viscous residue was dissolved in DCM (50.0 mL) and then neutralized using a saturated NaHCO3 aqueous solution. The organic phase was collected and poured into chilled methanol (300 mL). The PLA-NH2 product as white precipitates was collected using vacuum filtration and then dried at 70° C. overnight in vacuo.

### Synthesis Ofpolylactide-b-Poly(Amic Acid)-b-Polylactide (PLA-b-PAA-b-PLA) Triblock Copolymer.

To a 500-mL round bottom flask, PLA-NH2 (3.022 g), PMDA (2.588 g), and oDA (2.370 g) were dissolved in anhydrous DMSO (150.0 mL). The mixture was stirred at room temperature for 12 h and then heated at 100° C. for another 12 h.

### Preparation of Mesoporous Polyimide Film.

An aliquot of PLA-b-PAA-b-PLA in DMSO solution (5.0 mL) was mixed with acetic anhydride (220 μL) and pyridine (70 μL) and then poured onto a glass slide (7.0 cm by 7.0 cm). The solution layer was baked at 60° C. under reduced pressure to produce a thin film. The film was further baked stepwise at 100° C. for 1 h, 150° C. for 1 h, 220° C. for 1 h, 280° C. for 24 h and 350° C. for 1 h. The resulting thin film was peeled off from the supporting glass slide, and then both sides were etched using oxygen plasma for 30 min to enhance the wettability of the liquid electrolytes. The final porous polyimide thin film was cut into discs of 19 mm in diameter and used as battery separators.

### Battery Assembly and Tests.

The mesoporous polyimide separators were tested using electrochemical impedance spectroscopy (EIS), lithium-metal batteries, and lithium/lithium symmetric batteries. For EIS batteries, the separators were interposed between two stainless steel spaces, filled with 30 μL of electrolyte. For lithium-metal batteries, LiFePO4 on aluminum foil (12 mm in diameter) and lithium foil (15 mm in diameter) were employed as the cathodes and anodes, respectively. The volume of electrolyte was 60 μL. For lithium/lithium symmetric batteries, separators were inserted between two lithium-metal electrodes, filled with 60 μL of electrolyte.

### Results

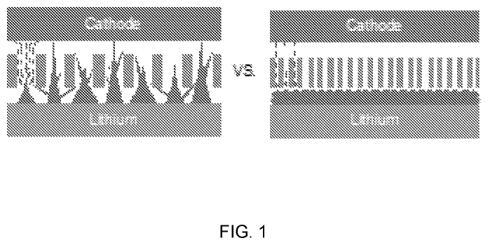

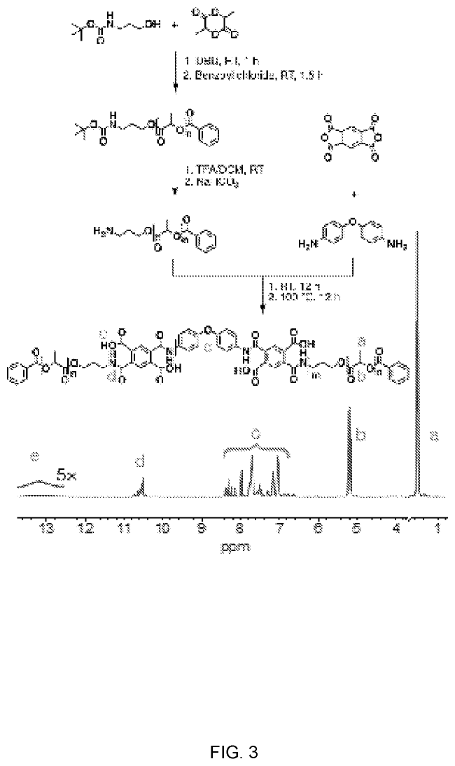

The mesoporous polyimide separators suppress Li dendrites following three mechanisms: i) the mesopores uniformly redistribute Li+ flux to the lithium-metal electrode, facilitating the even plating of lithium;^{[52,43]} ii) the mesopores are smaller than the typical width of lithium dendrites, therefore efficiently blocking the dendrites; iii) the high modulus ceases the invasion of lithium dendrites (FIG. 1).^{[1, 54-57]} To fulfill those characteristics, on the one hand, polyimide was selected as the matrix because it has high mechanical strength and high degradation temperature. On the other hand, PLA was selected as the sacrificial block owing to its reasonable thermolysis temperature that does not significantly soften the polyimide matrix. (FIG. 1). To synthesize the block copolymer, PLA with a number-average molecular weight (Mₙ) of 50 kDa was first synthesized via a ring-opening polymerization using 3-(Boc-amino)-1-propanol as the initiator and DBU as the catalyst (FIG. 3). The deprotection of tert-butoxycarbonyl (Boc) end group generated amine-terminated PLA (PLA-NH₂). Then, PLA-NH₂ was reacted with PMDA and oDA to produce a polylactide-b-poly(amic acid)-b-polylactide (PLA-b-PAA-b-PLA) triblock copolymer. A PLA volume fraction (ϕ_{PLA}) of 40% was targeted to access the bicontinuous phase of the triblock copolymer so that the final polyimide film would contain interconnected mesopores.^{[58]} The actual ϕ_{PLA} was determined based on ¹H NMR (FIG. 3). Peak b corresponded to the methine protons in PLA repeating units and Peak c to all aromatic protons in poly(amic acid) repeating units (FIG. 3). The integral ratio of Peak c and Peak b, I_{b}: I_{c}=39.0:100, indicated an actual ϕ_{PLA} of 40.2% using Equation 1.

$${ϕ}_{P L A} = \frac{{I}_{b} \times {M}_{P L A}}{{I}_{b} \times {M}_{P L A} + {I}_{c} / 10 \times {M}_{P A A}} \qquad ( Equation 1 )$$

where I_{b}, I_{c} are the integrals of Peak b and c, respectively. M_{PLA}=72.1 g/mol and M_{PAA}=418 g/mol are the molar masses of PLA and poly(amic acid) repeating units, respectively.

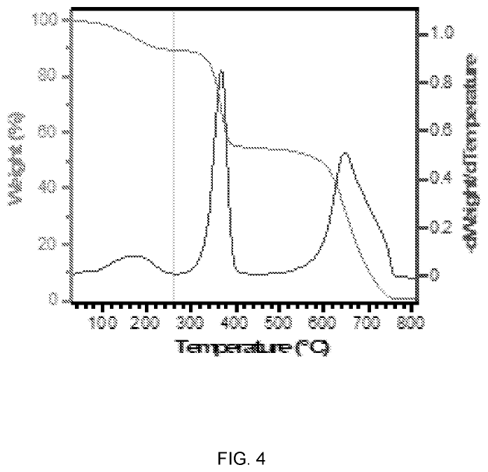

PLA-b-PAA-b-PLA triblock copolymers, mixed with acetic anhydride and pyridine, were cast into a thin film using DMSO as the solvent. Acetic anhydride and pyridine chemically imidized poly(amic acid) into polyimide, ensuring the film with high thermal and structural stabilities and to survive the subsequent thermolysis.^{[59]} Removing PLA without perturbing the polyimide matrix necessitated a low thermolysis temperature. Thermogravimetric analysis of polylactide-b-polyimide-b-polylactide (PLA-b-PI-b-PLA) thin films showed three weight-loss regimes (FIG. 4). The initial weight loss below 260° C. arose from the evaporation of volatile species such as the solvent and chemical imidization reagents. The weight loss between 26° and 440° C. was assigned to the thermal decomposition of PLA.^{[60]} The remaining weight evolving from 89.4% to 54.5% indicated a ϕ_{PLA} of 39.0% in the dry PLA-b-PI-b-PLA film, concurring with the ϕ_{PLA} calculated using ¹H NMR (FIG. 3). The weight loss above 440° C. was due to the decomposition of polyimide matrices.^{[61]} To remove the PLA phase without plasticizing the polyimide matrix, 280° C. was selected as the thermolysis temperature to prepare mesoporous polyimide thin films. To confirm that thermolysis at 280° C. could slowly remove the PLA phase, we used an isothermal gravimetric analysis to monitor the weight loss of PLA-b-PI-b-PLA for 24 h (FFIG. 5). The PLA decomposition in the first hour resulted in a weight loss of 8.3%. In the subsequent hours, the incremental weight loss per hour decreased gradually. The cumulative weight loss approached 37.5% after 24 h, implying the removal of most of the PLA phase.

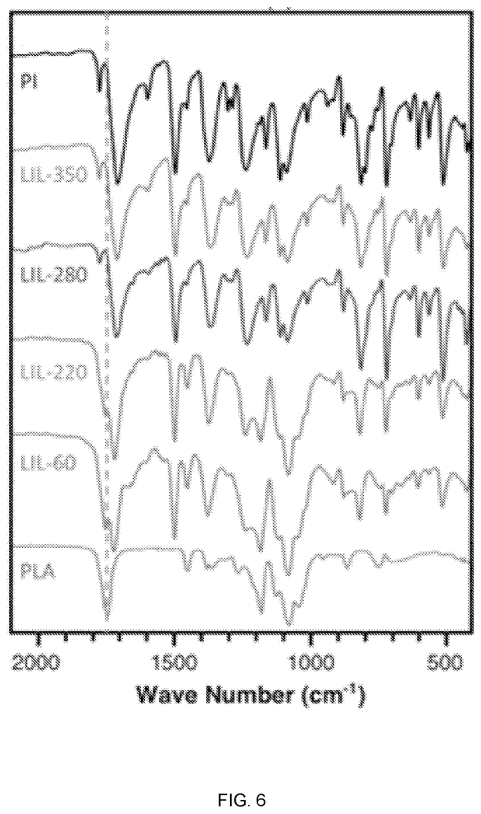

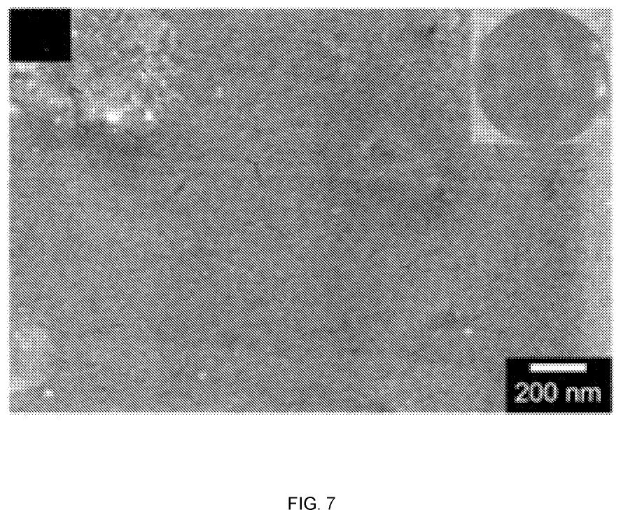

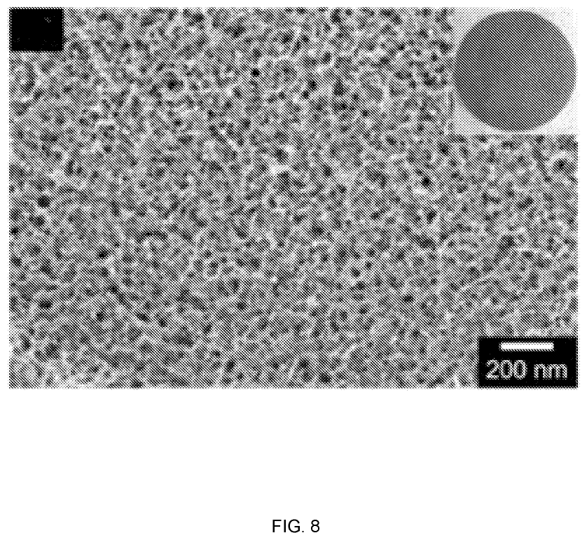

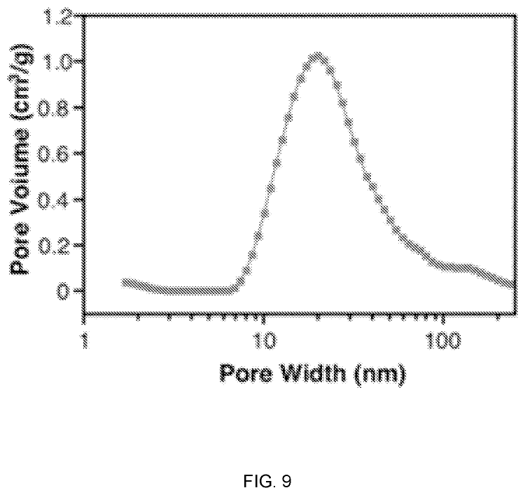

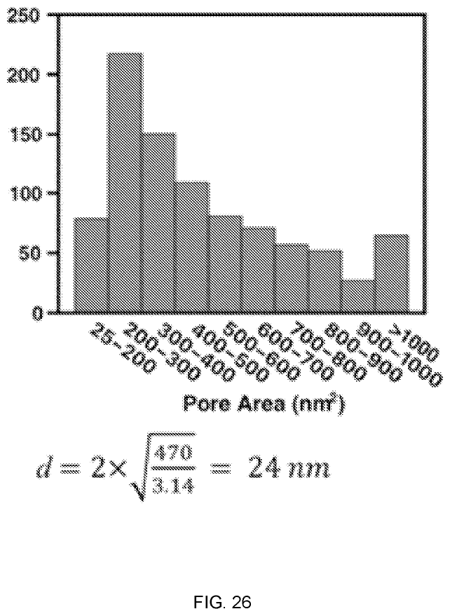

The evolution of the PLA content and the degree of imidization was recorded using ATR FT-IR employing the PLA-NH₂ and commercial PMDA-oDA polyimides as references (FIG. 6). The efficient chemical imidization of PLA-b-PI-b-PLA was confirmed by the profound peaks at 1777, 1717 and 1370 cm⁻¹, corresponding to the asymmetric stretching of C═O, symmetric stretching of C═O, and stretching of C-N in polyimides, respectively.^{[62-64]} The peak at 1752 cm⁻¹ was assigned to the C═O stretching of PLA.^{[65-67]} The PLA-b-PI-b-PLA thin film heating at 220° C. for 24 h retained a strong PLA C═O stretching. After the thermolysis at 280° C. for 24 h, the absence of C═O stretching at 1752 cm⁻¹ indicated the removal of PLA. PMDA-oDA polyimide usually requires a high temperature for complete imidization. After heating at 350° C. for 1 h, the appearance of PLA-b-PI-b-PLA resembled that of commercial polyimide, confirming a high degree of imidization. The morphologies of PLA-b-PI-b-PLA before and after thermolysis were imaged using SEM, confirming the mesopore development (FIGS. 7-9). The as-cast PLA-b-PI-b-PLA thin film showed a non-porous flat surface. After thermolysis, interconnected mesopores formed in the polyimide matrices. The color of PLA-b-PI-b-PLA films changed from amber to brownish due to the formation of charge-transfer complexes in polyimides.^{[68]} Nitrogen sorption analysis suggested the mesopores had a median size of 21 nm (FIGS. 9 and 26-27).

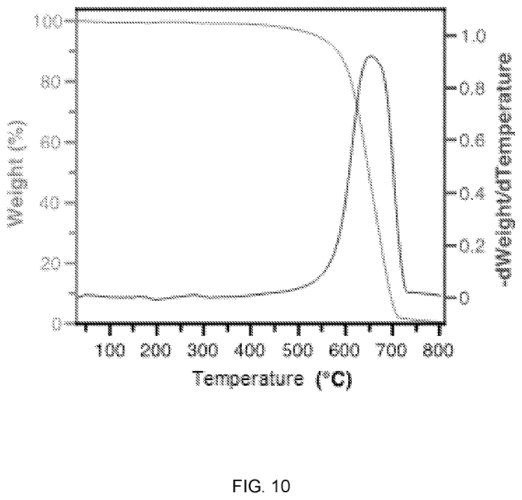

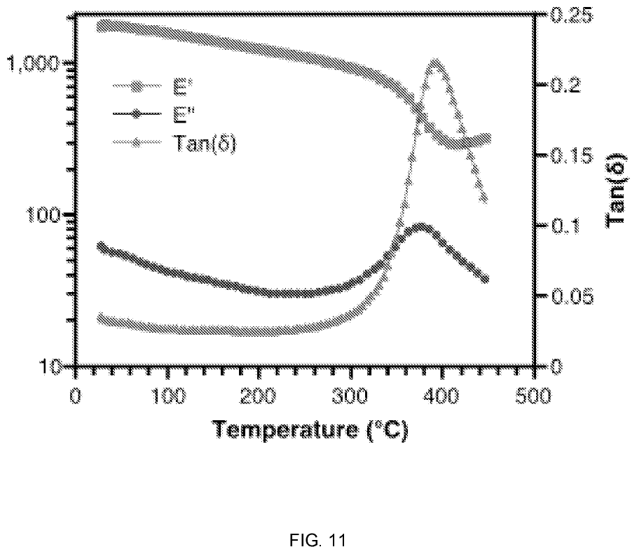

The mesoporous polyimide separators must have high thermal stability and mechanical strength to ensure electrode segregation both under working conditions and during the thermal runaway.^{[69]} Thermogravimetric analysis confirmed the excellent thermal stability of mesoporous polyimide films, showing a T_{d,5%} of 540° C. (FIG. 10). PLA was completely removed, as evidenced by no additional weight loss related to PLA. The thermomechanical properties of mesoporous polyimide were further tested using dynamic mechanical analysis (DMA). The mesoporous polyimide film exhibited a storage modulus (E) of ˜1.80 GPa at room temperature and retained an E′ of 0.94 GPa at 300° C. (FIG. 11). E′ was greater than E″ in the tested temperature range, affording a maximum of Tan(S) at 393° C. and confirming the high thermomechanical stability. The high modulus of mesopores polyimide separators would cease the dendritic growth and enable the safe cycling of lithium-metal batteries.^{[1,54]}

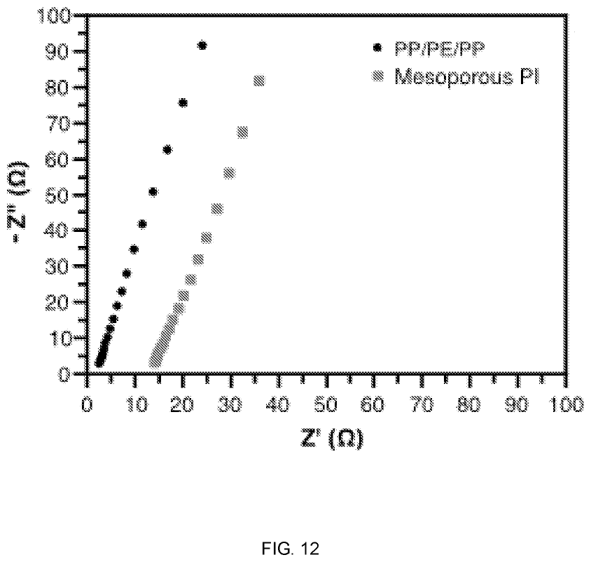

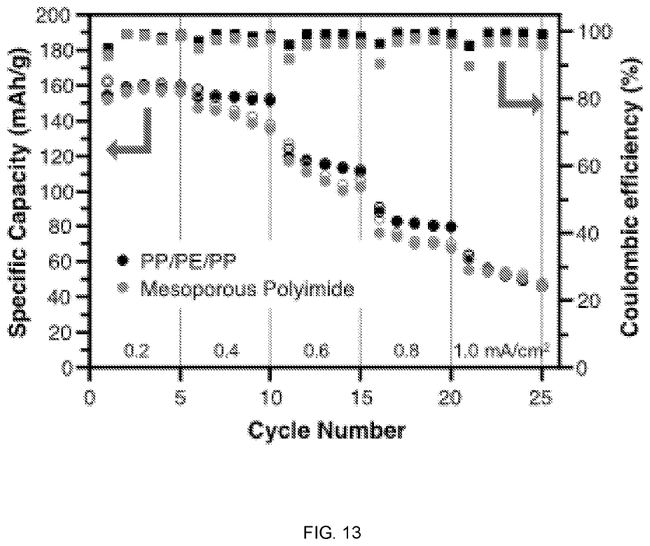

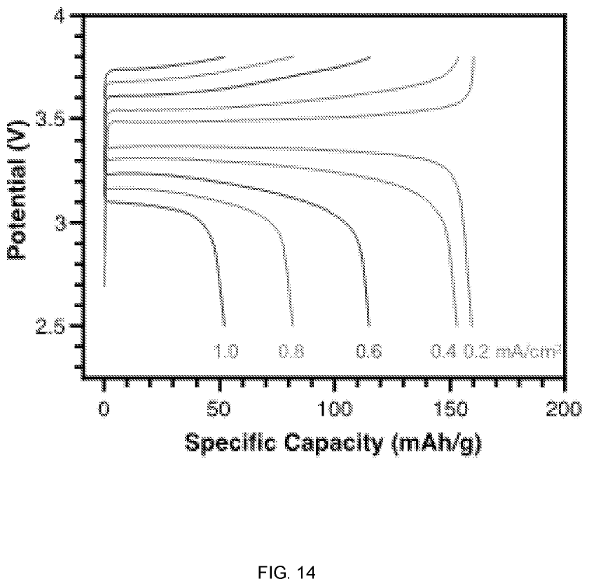

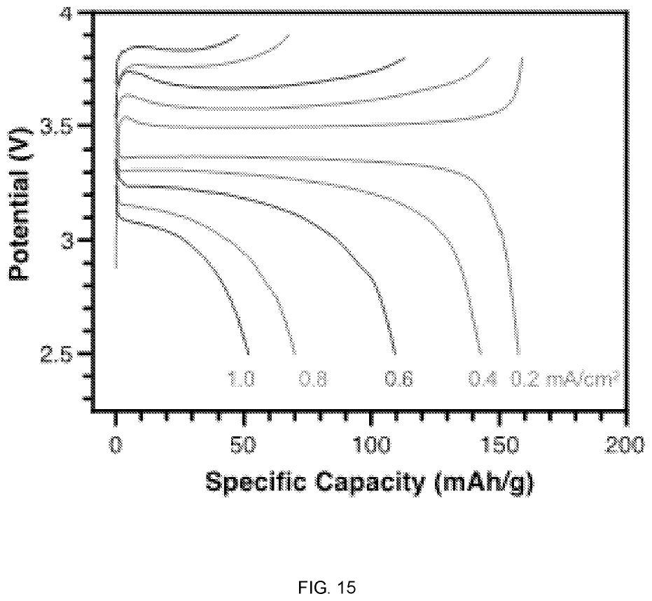

As a benchmark, the electrochemical performance of mesoporous polyimide was evaluated along with commercial PP/PE/PP separators. Electrochemical impedance of both separators was measured between two stainless steel spacers (FIG. 12). The impedance was 2.6 W for PP/PE/PP and 13 W for the mesoporous polyimide. The higher impedance of mesoporous polyimide separators was caused by the smaller pore size and thus hindered ion transport, which could be tuned by the block copolymer molecular weight and volume fraction. Both separators were tested in LiFePO4/lithium coin cells at increasing current densities from 0.2 to 1.0 mA/cm2. The mesoporous polyimide separator showed rate capabilities comparable to the PP/PE/PP separator (FIG. 13). Despite a higher ionic impedance than the PP/PE/PP separator, the mesoporous polyimide separator exhibited a slightly higher initial overpotential, e.g., 3.76 V vs. 3.70 V at a current density of 0.8 mA/cm2 (FIG. 14 and FIG. 15).

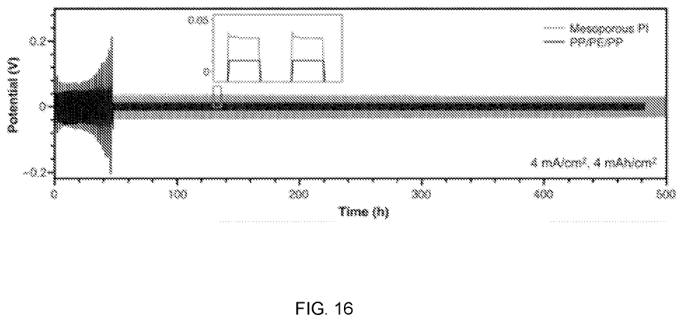

The dendrite-suppressing capability of mesoporous polyimide separators was tested in symmetric Li/Li batteries at a current density of 4 mA/cm2 and a capacity of 4 mAh/cm2 (FIG. 16). The symmetric Li/Li battery employing the PP/PE/PP separator showed a growing overpotential after 30 h, corresponding to the increasing internal impedance due to the dendritic growth, electrolyte consumption, and thick SEI formation. After 57 h, the lithium dendrites penetrated the PP/PE/PP separator and caused internal short circuit, resulting in an abrupt decrease of potential to 0.01 V. In contrast, the mesoporous polyimide separator effectively suppressed the lithium dendrites and retained a stable potential for >500 h.

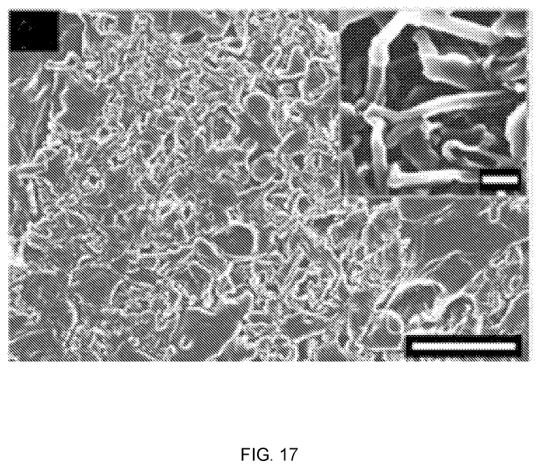

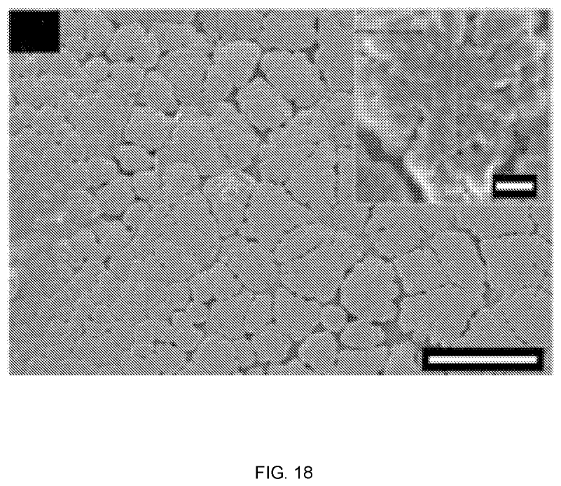

The morphologies of lithium-metal electrodes in both batteries were imaged using SEM after charging/discharging for 130 h (FIG. 17 and FIG. 18). With a PP/PE/PP separator in the battery, sharp lithium dendrites grew on the lithium-metal electrode and an average dendrite width was 200 nm (FIG. 17, and inset). Since the pore sizes in the PP/PE/PP separator were 40-400 nm,32 the lithium dendrites traversed the large pores and caused short circuits. In contrast, in the battery with mesoporous polyimide separator, flat-top lithium protrusions formed on the electrode, absent of any sharp lithium dendrites (FIG. 18, and inset).

The mesoporous polyimide separators showed outstanding dendrite-suppressing capability because of three characteristics: i) the mesopores allow uniform Li+ flux across the separator, minimizing the dendritic growth;49-50 ii) the mesopore width is smaller than the width of lithium dendrites, preventing dendrites from penetrating the separator; iii) the high modulus withstand the high axial stress, ceasing the invasion of lithium dendrites. 1,51-54 The smaller pore size, however, slows down ion transport, resulting in a slightly higher overpotential. Reducing the ionic impedance will be an important aspect of future optimizations. Decreasing the thickness of mesoporous polyimide separators and shortening the ion diffusion length will be an attractive means to reduce the apparent ionic impedance.

### SUMMARY

In these examples, a mesoporous polyimide thin film was produced via slow thermolysis of a polylactide-b-polyimide-b-polylactide triblock copolymer. The slow thermolysis at 280° C. gradually removed polylactide to create mesopores of 21 nm, without perturbing the polyimide matrix. The resulting mesoporous polyimide thin films exhibited a storage modulus of 1.80 GPa. The mesoporous structures and high modulus together contributed to excellent dendrite-suppressing capability. Separated by mesoporous polyimide, lithium only formed flat-top protrusions, enabling safe cycling for >500 h. This examples highlights the ability of the films described herein having uniform mesoporous engineering polymers for dendrite suppression.

### REFERENCES

1. He, Y.; Ren, X.; Xu, Y.; Engelhard, M. H.; Li, X.; Xiao, J.; Liu, J.; Zhang, J. G.; Xu, W.; Wang, C. Nat. Nanotechnol. 2019, 14, 1042-1047.
2. Cao, X.; Ren, X.; Zou, L.; Engelhard, M. H.; Huang, W.; Wang, H.; Matthews, B. E.; Lee, H.; Niu, C.; Arey, B. W.; Cui, Y.; Wang, C.; Xiao, J.; Liu, J.; Xu, W.; Zhang, J.-G. Nat. Energy 2019, 4, 796-805.
3. Tarascon, J. M.; Armand, M. Nature 2001, 414, 359-367.
4. Li, L.; Base, S.; Wang, Y.; Chen, Z.; Hundekar, P.; Wang, B.; Shi, J.; Shi, Y.; Narayanan, S.; Koratkar, N. Science 2018, 359, 1513-1516.
5. Mukhopadhyay, A.; Jangid, M. K. Science 2018, 359, 1463.
6. Lin, D.; Liu, Y.; Cui, Y. Nat. Nanotechnol. 2017, 12, 194-206.
7. Frenck, L.; Sethi, G. K.; Maslyn, J. A.; Balsara, N. P. Front. Energy Res. 2019, 7, 115.
8. Bieker, G.; Winter, M.; Bieker, P. Phys. Chem. Chem. Phys. 2015, 17, 8670-9.
9. Niu, C.; Pan, H.; Xu, W.; Xiao, J.; Zhang, J. G.; Luo, L.; Wang, C.; Mei, D.; Meng, J.; Wang, X.; Liu, Z.; Mai, L.; Liu, J. Nat. Nanotechnol. 2019, 14, 594-601.
10. Bai, P.; Li, J.; Brushett, F. R.; Bazant, M. Z. Energy Environ. Sci. 2016, 9, 3221-3229.
11. Deng, Q.; Hu, R.; Xu, C.; Chen, B.; Zhou, J. J. Solid State Electrochem. 2019, 23, 2999-3008.
12. Peled, E.; Menkin, S. J. Electrochem. Soc. 2017, 164, A1703-A1719.
13. Shi, F.; Pei, A.; Boyle, D. T.; Xie, J.; Yu, X.; Zhang, X.; Cui, Y. Proc. Natl. Acad. Sci. USA 2018, 115, 8529-8534.
14. Gireaud, L.; Grugeon, S.; Laruelle, S.; Yrieix, B.; Tarascon, J. M. Electrochem. Commun. 2006, 8, 1639-1649.
15. Liu, Z.; Zinkevich, T.; Indris, S.; He, X.; Liu, J.; Xu, W.; Bai, J.; Xiong, S.; Mo, Y.; Chen, H. Inorg. Chem. 2019, 59, 226-234.
16. Chen, R.; Li, Q.; Yu, X.; Chen, L.; Li, H. Chem Rev 2020, 120, 6820-6877.
17. Ji, X.; Hou, S.; Wang, P.; He, X.; Piao, N.; Chen, J.; Fan, X.; Wang, C. Adv. Mater. 2020, 32, 2002741.
18. Ansari, Y.; Guo, B.; Cho, J. H.; Park, K.; Song, J.; Ellison, C. J.; Goodenough, J. B. J. Electrochem. Soc. 2014, 161, A1655-A1661.
19. Chen, S.; Zheng, J.; Mei, D.; Han, K. S.; Engelhard, M. H.; Zhao, W.; Xu, W.; Liu, J.; Zhang, J. G. Adv. Mater. 2018, 30, 1706102.
20. Li, Q.; Tan, S.; Li, L.; Lu, Y.; He, Y. Sci. Adv. 2017, 3, 1701246.
21. Maeyoshi, Y.; Ding, D.; Kubota, M.; Ueda, H.; Abe, K.; Kanamura, K.; Abe, H. ACS Appl. Mater. Interfaces 2019, 11, 25833-25843.
22. Wang, J.; Huang, W.; Pei, A.; Li, Y.; Shi, F.; Yu, X.; Cui, Y. Nat. Energy 2019, 4, 664-670.
23. Cao, D.; Xing, Y.; Tantratian, K.; Wang, X.; Ma, Y.; Mukhopadhyay, A.; Cheng, Z.; Zhang, Q.; Jiao, Y.; Chen, L.; Zhu, H. Adv. Mater. 2019, 31, 1807313.
24. Xie, J.; Wang, J.; Lee, H. R.; Yan, K.; Li, Y.; Shi, F.; Huang, W.; Pei, A.; Chen, G.; Subbaraman, R.; Christensen, J.; Cui, Y. Sci. Adv. 2018, 4, eaat5168.
25. Zhao, C.-Z.; Chen, P.-Y.; Zhang, R.; Chen, X.; Li, B.-Q.; Zhang, X.-Q.; Cheng, X.-B.; Zhang, Q. Sci. Adv. 2018, 4, eaat3446.
26. Fang, C.; Lu, B.; Pawar, G.; Zhang, M.; Cheng, D.; Chen, S.; Ceja, M.; Doux, J.-M.; Musrock, H.; Cai, M.; Liaw, B.; Meng, Y. S. Nat. Energy 2021, 6, 987-994.
27. Guo, J.; Wen, Z.; Wu, M.; Jin, J.; Liu, Y. Electrochem. Commun. 2015, 51, 59-63.
28. Varzi, A.; Raccichini, R.; Passerini, S.; Scrosati, B. J. Mater. Chem. A 2016, 4, 17251-17259.
29. Zhao, Q.; Liu, X.; Stalin, S.; Khan, K.; Archer, L. A. Nat. Energy 2019, 4, 365-373.
30. Zhao, W.; Yi, J.; He, P.; Zhou, H. EER 2019, 2, 574-605.
31. Horstmann, B.; Shi, J.; Amine, R.; Werres, M.; He, X.; Jia, H.; Hausen, F.; Cekic-Laskovic, I.; Wiemers-Meyer, S.; Lopez, J.; Galvez-Aranda, D.; Baakes, F.; Bresser, D.; Su, C.-C.; Xu, Y.; Xu, W.; Jakes, P.; Eichel, R.-A.; Figgemeier, E.; Krewer, U.; Seminario, J. M.; Balbuena, P. B.; Wang, C.; Passerini, S.; Shao-Horn, Y.; Winter, M.; Amine, K.; Kostecki, R.; Latz, A. Energy Environ. Sci. 2021, 14, 5289-5314.
32. Peter, C.; Nikolowski, K.; Reuber, S.; Wolter, M.; Michaelis, A. J. Appl. Electrochem. 2020, 50, 295-309.
33. Miyata, S.; Yoshida, K.; Shirokura, H.; Kashio, M.; Nagai, K. Polym. Int. 2009, 58, 1148-1159.
34. Fu, G. D.; Zong, B. Y.; Kang, E. T.; Neoh, K. G.; Lin, C. C.; Liaw, D. J. Ind. Eng. Chem. Res. 2004, 43, 6723-6730.
35. Hedrick, J. L.; Hawker, C. J.; DiPietro, R.; Jérôme, R.; Charlier, Y. Polymer 1995, 36, 4855-4866.
36. Guo, D.; Khan, A. U.; Liu, T.; Zhou, Z.; Liu, G. Polym. Chem. 2019, 10, 379-385.
37. Hedrick, J. L.; DiPietro, R.; Plummer, C. J. G.; Hilborn, J.; Jérôme, R. Polymer 1996, 37, 5229-5236.
38. Charlier, Y.; Hedrick, J. L.; Russell, T. P.; Swanson, S.; Sanchez, M.; Jérôme, R. Polymer 1995, 36, 1315-1320.
39. Hedrick, J. L.; Russell, T. P.; Sanchez, M.; DiPietro, R.; Swanson, S. Macromolecules 1996, 29, 3642-3646.
40. Ju, J.; Wang, Q.; Wang, T.; Wang, C. J. Colloid Interface Sci. 2013, 404, 36-41.
41. Meleshko, T. K.; Kashina, A. V.; Saprykina, N. N.; Kostyuk, S. V.; Vasilenko, I. V.; Nikishev, P. A.; Yakimanskii, A. V. Russ. J. Appl. Chem. 2017, 90, 602-612.
42. Liu, C.; Liu, B.; Chan-Park, M. B. Polym. Chem. 2017, 8, 674-681.
43. Wang, L.; Lu, J.; Liu, M.; Lin, L.; Li, J. Particuology 2014, 14, 63-70.
44. Hedrick, J. L.; Carter, K.; Sanchez, M.; Pietro, R. D.; Swanson, S. Macromol. Chem. Phys. 1997, 198, 549-559.
45. Hedrick, J. L.; Russell, T. P.; Labadie, J.; Lucas, M.; Swanson, S. Polymer 1995, 36, 2685-2697.
46. Chung, C.-M.; Lee, J.-H.; Cho, S.-Y.; Kim, J.-G.; Moon, S.-Y. J. Appl. Polym. Sci. 2006, 101, 532-538.
47. Charlier, Y.; Hedrick, J.; Volksen, W. Polymer 1995, 36, 987-1002.
48. Carter, K. R.; DiPietro, R. A.; Sanchez, M. I.; Swanson, S. A. Chem. Mater. 2001, 13, 213-221.
49. Chen, X. R.; Yao, Y. X.; Yan, C.; Zhang, R.; Cheng, X. B.; Zhang, Q. Angew. Chem. Int. Ed. 2020, 59, 7743-7747.
50. Nagasaki, M.; Kanamura, K. ACS Appl. Energy Mater. 2019, 2, 3896-3903.
51. Ferrese, A.; Newman, J. J. Electrochem. Soc. 2014, 161, A1350-A1359.
52. Monroe, C.; Newman, J. J. Electrochem. Soc. 2005, 152, A396-A404.
53. Na, W.; Lee, A. S.; Lee, J. H.; Hwang, S. S.; Kim, E.; Hong, S. M.; Koo, C. M. ACS Appl. Mater. Interfaces 2016, 8, 12852-12858.
54. Wan, J.; Xie, J.; Kong, X.; Liu, Z.; Liu, K.; Shi, F.; Pei, A.; Chen, H.; Chen, W.; Chen, J.; Zhang, X.; Zong, L.; Wang, J.; Chen, L. Q.; Qin, J.; Cui, Y. Nat. Nanotechnol. 2019, 14, 705-711.
55. Guo, D.; Riet, J.; Khan, A.; Guo, Y.; Xu, Z.; Liu, T.; Liu, G. Polym. Chem. 2021, 12, 3939-3946.
56. Yu, H.-C.; Jung, J.-W.; Choi, J.-Y.; Chung, C.-M. J. Polym. Sci., Part A: Polym. Chem. 2016, 54, 1593-1602.
57. Ohkita, T.; Lee, S.-H. J. Appl. Polym. Sci. 2006, 100, 3009-3017.
58. Zaragoza, S.; Álvarez, A.; Álvarez, B.; López-Beceiro, J.; Naya, S.; Forc6n, P.; Artiaga, R. J. Appl. Polym. Sci. 2015, 132, 42329.
59. Lee, S.-C.; Tai, F.-C.; Wei, C.-H.; Yu, J.-I. Mater. Trans. 2007, 48, 1554-1557.
60. Wang, C.; Cao, S.; Chen, W.; Xu, C.; Zhao, X.; Li, J.; Ren, Q. RSC Adv. 2017, 7,26420-26427.
61. Grabiec, E.; Schab-Balcerzak, E.; Wolinska-Grabczyk, A.; Jankowski, A.; Jarza̧bek, B.; Koźuch-Krawczyk, J.; Kurcok, M. Polym. J. 2011, 43, 621-629.
62. Savaris, M.; Braga, G. L.; dos Santos, V.; Carvalho, G. A.; Falavigna, A.; Machado, D. C.; Viezzer, C.; Brandalise, R. N. Int. J. Polym. Sci. 2017, 2017, 1-9.
63. Cuiffo, M. A.; Snyder, J.; Elliott, A. M.; Romero, N.; Kannan, S.; Halada, G. P. Appl. Sci. 2017, 7, 579.
64. Tang, G.; Huang, X.; Ding, H.; Wang, X.; Jiang, S.; Zhou, K.; Wang, B.; Yang, W.; Hu, Y. RSC Adv. 2014, 4, 8985-8993.
65. Lee, T.-H.; Kim, J. H.; Bae, B.-S. J. Mater. Chem. 2006, 16, 1657-1664.
66. Zhu, Y.; Xie, J.; Pei, A.; Liu, B.; Wu, Y.; Lin, D.; Li, J.; Wang, H.; Chen, H.; Xu, J.; Yang, A.; Wu, C.-L.; Wang, H.; Chen, W.; Cui, Y. Nat. Commun. 2019, 10, 1-7.
67. Friedman, M. J. Agric. Food Chem. 2004, 52, 386-406.

1. A method of preparing a mesoporous polyimide membrane comprising:
a) casting an A-B, A-B-A, or A-B-C block copolymer on a substrate to form a precursor film, wherein A and C are each independently thermally labile blocks, and wherein B is a polyimide block;
b) heating the precursor film to a temperature from about 100° C. to about 300° C. for a time interval to form the polyimide membrane;
wherein the mesoporous polyimide membrane comprises a plurality of mesopores wherein a median diameter of the mesopores is from about 5 nm to about 20 nm as measured by the Nitrogen Sorption Protocol.

2. The method of claim 1, further comprising prior to the casting step:
(i) preparing an A-D, A-D-A, or A-D-C block copolymer, wherein A and C are each independently thermally labile blocks and D is a poly(amic acid) block; and
ii) treating the A-D, A-D-A, or A-D-C block copolymer with an anhydride and a base to form the A-B, A-B-A, or A-B-C block copolymer.

3. The method of claim 1, wherein the thermally labile blocks are each independently selected from the group consisting of a polyacrylate, a vinyl polymer, a styrenic polymer, a polyester, and a polyether.

4. The method of claim 1, further comprising prior to the casting step:
(i) preparing a polylactide-b-poly(amic acid)-b-polylactide (PLA-b-PAA-b-PLA) triblock copolymer; and
(ii) treating the PLA-b-PAA-b-PLA triblock copolymer with an anhydride and a base to form the A-B-A triblock copolymer.

5. The method of claim 1, further comprising prior to the casting step:
(i) preparing a polylactide-b-poly(amic acid) (PLA-b-PAA) diblock copolymer; and
(ii) treating the PLA-b-PAA diblock copolymer with an anhydride and a base to form the A-B block copolymer.

6. The method of claim 1 wherein one or both of the thermally labile blocks are polyacrylates selected from the group consisting of a polyethyl acrylate (PEA), a poly(n-butyl acrylate) (PBA), a poly(methyl acrylate) (PMA), a poly(methyl methacrylate) (PMMA), a poly(2-hydroxyethyl acrylate) (PHEA), and copolymers thereof.

7. The method of claim 1, wherein one or both of the thermally labile blocks are vinyl polymers selected from the group consisting of a polyvinyl alcohol (PVA), a polyvinyl acetate (PVAc), a polyvinyl chloride (PVC), a polyvinylidine chloride (PVDC), and copolymers thereof.

8. The method of claim 1, wherein one or both of the thermally labile blocks are styrenic polymers selected from the group consisting of polystyrene (PS), poly(styrene-acrylonitrile) (SAN), poly(styrene-butadiene-styrene) (SBS), poly(styrene-ethylene/butyliene-styrene) (SEBS), and copolymers thereof.

9. The method of claim 1, wherein one or both of the thermally labile blocks are polyesters selected from the group consisting of a polyethylene terephthalate (PET), a polybutylene adipate-co-terephthalate (PBAT), a polytrimethylene terephthalate (PTT), a polyethylene succinate (PES), and copolymers thereof.

10. The method of claim 1, wherein one or both of the thermally labile blocks are polyethers selected from the group consisting of a polyethylene oxide (PEO), a polypropylene oxide (PPO), a poly(tetramethylene ether)glycol (PTMEG), a poly(ethylene-co-propylene glycol) (PPEG), and copolymers thereof.

11. The method of claim 1, wherein the thermally labile blocks comprise polylactide.

12. The method of claim 1, wherein the thermally labile block has a thermolysis temperature of about 270° C., about 250° C., about 230° C., about 200° C., or less.

13. (canceled)

14. The method of claim 1, wherein a median pore width of the mesopores is from about 10 nm to about 40 nm.

15. (canceled)

16. The method of claim 1, wherein the membrane has a thickness of from about 5 to about 50 microns.

17. (canceled)

18. (canceled)

19. The method of claim 1, wherein the time interval comprises about thirty minutes to about 48 hours, about 30 minutes to about 3 hours, or about 12 hours to about 36 hours.

20. The method of claim 1 wherein the temperature is from about 100° C. to below 280° C.

21. (canceled)

22. A mesoporous polyimide membrane comprising a polyimide membrane having a plurality of mesopores,
wherein a median diameter of the mesopores is from about 5 nm to about 20 nm as measured by the Nitrogen Sorption Protocol, and
wherein the mesopores are isoporous.

23. The mesoporous polyimide membrane of claim 22 wherein the mesoporous polyimide membrane has a storage modulus of from 1.5 to 2.5 GPa as measured by the Storage Modulus Protocol.

24. (canceled)

25. (canceled)

26. (canceled)

27. (canceled)

28. The mesoporous polyimide membrane of claim 22 wherein the membrane thickness is from about 20 to about 25 microns.

29. (canceled)

30. An electrochemical device comprising:
(a) an anode;
(b) a cathode;
(c) the electrochemical cell separator material comprising the mesoporous polyimide membrane of claim 22 mounted between the anode and the cathode; and
(d) an electrolyte.

31-54. (canceled)
